(19) United States
(12) Patent Application Publication
(10) Pub. No.: US 2026/0231206 A1
(43) Pub. Date: Aug. 6, 2026

(54) USING A SHARED CHANNEL OCCUPANCY TIME ACROSS MULTIPLE SESSIONS OR CASTS

(71) Applicant: QUALCOMM Incorporated, San Diego, CA (US)

(72) Inventors: Giovanni CHISCI, San Diego, CA (US); Chih-Hao LIU, San Diego, CA (US); Jing SUN, San Diego, CA (US); Stelios STEFANATOS, San Diego, CA (US); Xiaoxia ZHANG, San Diego, CA (US); Qing LI, Princeton Junction, NJ (US)

(21) Appl. No.: 19/148,170

(22) PCT Filed: Feb. 12, 2024
(86) PCT No.: PCT/US2024/015376

§ 371 Date: Jul. 15, 2025

(30) Foreign Application Priority Data
Feb. 14, 2023 (GR) 20230100126

(51) Int. Cl. H04W 74/04; H04W 72/044

(52) U.S. Cl. CPC H04W 74/04; H04W 72/044

(57) ABSTRACT

Various aspects of the present disclosure generally relate to wireless communication. In some aspects, a responder user equipment (UE) may receive, from an initiator UE, a channel occupancy time (COT) sharing information (COT-SI) indicating resources associated with a COT. The UE may identify that the initiator UE is a target of a transport block (TB) based at least in part on mapping a link identifier associated with the TB to a logical identifier indicated by the COT-SI. The UE may transmit the TB to the initiator UE using the resources associated with the COT based at least in part on identifying that the initiator UE is the target of the TB. Numerous other aspects are described.

### CROSS-REFERENCE TO RELATED APPLICATION

This Patent Application claims priority to Greece Provisional Patent Application No. 20230100126, filed on Feb. 14, 2023, entitled “USING A SHARED CHANNEL OCCUPANCY TIME ACROSS MULTIPLE SESSIONS OR CASTS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for using a shared channel occupancy time across multiple sessions or casts.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a responder user equipment (UE) for wireless communication. The responder user equipment may include one or more memories and one or more processors coupled to the one or more memories. The one or more processors may be configured to receive, from an initiator UE, a channel occupancy time (COT) sharing information (COT-SI) indicating resources associated with a COT. The one or more processors may be configured to identify that the initiator UE is a target of a transport block (TB) based at least in part on mapping a link identifier associated with the TB to a logical identifier indicated by the COT-SI. The one or more processors may be configured to transmit the TB to the initiator UE using the resources associated with the COT based at least in part on identifying that the initiator UE is the target of the TB.

Some aspects described herein relate to an initiator UE for wireless communication. The initiator user equipment may include one or more memories and one or more processors coupled to the one or more memories. The one or more processors may be configured to transmit, to a responder UE, a COT-SI indicating resources associated with a COT and one or more logical identifiers associated with the COT. The one or more processors may be configured to receive, from the responder UE, a TB using the resources associated with the COT based at least in part on a mapping of a link identifier associated with the TB to a logical identifier indicated by the COT-SI.

Some aspects described herein relate to a method of wireless communication performed by a responder UE. The method may include receiving, from an initiator UE, a COT-SI indicating resources associated with a COT. The method may include identifying that the initiator UE is a target of a TB based at least in part on mapping a link identifier associated with the TB to a logical identifier indicated by the COT-SI. The method may include transmitting the TB to the initiator UE using the resources associated with the COT based at least in part on identifying that the initiator UE is the target of the TB.

Some aspects described herein relate to a method of wireless communication performed by an initiator UE. The method may include transmitting, to a responder UE, a COT-SI indicating resources associated with a COT and one or more logical identifiers associated with the COT. The method may include receiving, from the responder UE, a TB using the resources associated with the COT based at least in part on a mapping of a link identifier associated with the TB to a logical identifier indicated by the COT-SI.

Some aspects described herein relate to a method of wireless communication performed by a responder UE. The method may include receiving, from an initiator UE, a COT-SI indicating resources associated with a COT. The method may include identifying that the initiator UE is a target of a TB based at least in part on at least one of mapping a logical identifier associated with the TB to a global identifier associated with the initiator UE, or mapping the logical identifier associated with the TB to a logical identifier indicated by the COT-SI. The method may include transmitting the TB to the initiator UE using the resources associated with the COT based at least in part on identifying that the initiator UE is the target of the TB.

Some aspects described herein relate to a method of wireless communication performed by an initiator UE. The method may include transmitting, to a responder UE, a COT-SI indicating resources associated with a COT and at least one of a global identifier associated with the initiator UE, or one or more logical identifiers associated with the COT. The method may include receiving, from the responder UE, a TB using the resources associated with the COT based at least in part on at least one of a mapping of a logical identifier associated with the TB to the global identifier associated with the initiator UE, or a mapping of a logical identifier associated with the TB to a logical identifier indicated by the COT-SI.

Some aspects described herein relate to a responder UE for wireless communication. The responder UE may include a memory and one or more processors coupled to the memory. The one or more processors may be configured to receive, from an initiator UE, a COT-SI indicating resources associated with a COT. The one or more processors may be configured to identify that the initiator UE is a target of a TB based at least in part on at least one of mapping a logical identifier associated with the TB to a global identifier associated with the initiator UE, or mapping the logical identifier associated with the TB to a logical identifier indicated by the COT-SI. The one or more processors may be configured to transmit the TB to the initiator UE using the resources associated with the COT based at least in part on identifying that the initiator UE is the target of the TB.

Some aspects described herein relate to an initiator UE for wireless communication. The initiator UE may include a memory and one or more processors coupled to the memory. The one or more processors may be configured to transmit, to a responder UE, a COT-SI indicating resources associated with a COT and at least one of a global identifier associated with the initiator UE, or one or more logical identifiers associated with the COT. The one or more processors may be configured to receive, from the responder UE, a TB using the resources associated with the COT based at least in part on at least one of a mapping of a logical identifier associated with the TB to the global identifier associated with the initiator UE, or a mapping of a logical identifier associated with the TB to a logical identifier indicated by the COT-SI.

Some aspects described herein relate to a non-transitory computer-readable medium that stores a set of instructions for wireless communication by a responder UE. The set of instructions, when executed by one or more processors of the responder UE, may cause the responder UE to receive, from an initiator UE, a COT-SI indicating resources associated with a COT. The set of instructions, when executed by one or more processors of the responder UE, may cause the responder UE to identify that the initiator UE is a target of a TB based at least in part on at least one of mapping a logical identifier associated with the TB to a global identifier associated with the initiator UE, or mapping the logical identifier associated with the TB to a logical identifier indicated by the COT-SI. The set of instructions, when executed by one or more processors of the responder UE, may cause the responder UE to transmit the TB to the initiator UE using the resources associated with the COT based at least in part on identifying that the initiator UE is the target of the TB.

Some aspects described herein relate to a non-transitory computer-readable medium that stores a set of instructions for wireless communication by an initiator UE. The set of instructions, when executed by one or more processors of the initiator UE, may cause the initiator UE to transmit, to a responder UE, a COT-SI indicating resources associated with a COT and at least one of a global identifier associated with the initiator UE, or one or more logical identifiers associated with the COT. The set of instructions, when executed by one or more processors of the initiator UE, may cause the initiator UE to receive, from the responder UE, a TB using the resources associated with the COT based at least in part on at least one of a mapping of a logical identifier associated with the TB to the global identifier associated with the initiator UE, or a mapping of a logical identifier associated with the TB to a logical identifier indicated by the COT-SI.

Some aspects described herein relate to an apparatus for wireless communication. The apparatus may include means for receiving, from an initiator UE, a COT-SI indicating resources associated with a COT. The apparatus may include means for identifying that the initiator UE is a target of a TB based at least in part on at least one of mapping a logical identifier associated with the TB to a global identifier associated with the initiator UE, or mapping the logical identifier associated with the TB to a logical identifier indicated by the COT-SI. The apparatus may include means for transmitting the TB to the initiator UE using the resources associated with the COT based at least in part on identifying that the initiator UE is the target of the TB.

Some aspects described herein relate to an apparatus for wireless communication. The apparatus may include means for transmitting, to a responder UE, a COT-SI indicating resources associated with a COT and at least one of a global identifier associated with the apparatus, or one or more logical identifiers associated with the COT. The apparatus may include means for receiving, from the responder UE, a TB using the resources associated with the COT based at least in part on at least one of a mapping of a logical identifier associated with the TB to the global identifier associated with the apparatus, or a mapping of a logical identifier associated with the TB to a logical identifier indicated by the COT-SI.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications and access link communications, in accordance with the present disclosure.

FIGS. 5A-5B are diagrams illustrating an example of sidelink communications, in accordance with the present disclosure.

FIGS. 6A-6C are diagrams illustrating an example associated with logical source and destination identifier fields associated with a sidelink communication, in accordance with the present disclosure.

FIGS. 7A-7N is a diagram of an example associated with using a shared channel occupancy time across multiple sessions or casts, in accordance with the present disclosure.

FIG. 8 is a diagram illustrating an example process performed, for example, by a responder UE, in accordance with the present disclosure.

FIG. 9 is a diagram illustrating an example process performed, for example, by an initiator UE, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In some wireless communication networks, a user equipment (UE) may communicate with another UE via a sidelink. In some instances, the UEs may communicate in an unlicensed spectrum, sometimes referred to as sidelink-unlicensed (SL-U). In the unlicensed spectrum, various wireless communication devices may be competing for use of the airwaves, and thus a UE may perform a listen-before-talk (LBT) procedure to identify open time and/or frequency resources for communicating with another UE. Such time and/or frequency resources may be referred to as a channel occupancy time (COT). In some examples, a first UE may perform the LBT procedure to identify the COT, which is sometimes referred to as a Type 1 channel access procedure. The first UE may then share the COT with a second UE, which may transmit a communication using the COT without performing the full LBT procedure, which is sometimes referred to as a Type 2 channel access procedure. In some cases, a UE may only be permitted to transmit certain communications using a shared COT (e.g., using a Type 2 channel access procedure). For example, a UE transmitting a transport block (TB) to another UE via a physical sidelink control channel (PSCCH) or a physical sidelink shared channel (PSSCH) may only be permitted to use a shared COT if the UE that shared the COT (e.g., the UE that initially performed the LBT procedure) is a target of the data transmission. However, a physical (PHY) layer of a UE, which is a layer which has access to the shared COT information, does not have access to full Layer 2 (L2) identifiers (IDs) associated with receiving UEs (which, instead, are maintained at a medium access control (MAC) layer of the UE), and thus the PHY layer may make a determination as to whether a shared COT may be used based on less-complete, Layer 1 (L1) logical IDs. This may lead to the UE erroneously attempting to use a shared COT for an ineligible communication, resulting in communication errors and thus high power, computing, and network resource consumption for correcting the communication errors. Moreover, if a UE receives an indication of the shared COT in a first communication session or a first cast associated with a first logical ID, and the UE responds in a second communication session or a second cast associated with a second (e.g., different) logical ID, the UE may not identify whether the first and second logical IDs are associated with the same initiator UE (e.g., the UE that reserved the COT), and thus the UE may be required to perform a Type 1 channel access procedure even in instances in which the shared COT could have been used. This may lead to increased latency and network resource consumption, and otherwise inefficient usage of network resources.

Some techniques and apparatuses described herein enable mapping of a logical ID associated with a TB to one of a global ID associated with a UE that shared COT information and/or a logical ID associated with a shared COT, thereby permitting a sending UE to identify whether a shared COT may be used for transmitting the TB. In some aspects, a UE sharing COT information (sometimes referred to herein as an initiating UE, an initiator UE, and/or a COT initiator UE) may transmit, and another UE (sometimes referred to herein as a responding UE, a responder UE, and/or a COT responder UE) may receive, a COT sharing information (COT-SI) indicating resources associated with a COT, a global ID associated with the initiator UE, and/or one or more logical IDs associated with the COT. When the responder UE then has a TB associated with a logical ID to be transmitted (e.g., a TB to be transmitted by the responder UE using a communication session and/or cast type associated with the logical ID), the responder ID may map the logical ID to a global ID associated with the initiator UE and/or a logical ID associated with the COT. Based at least in part on the mapping, which is indicative that the TB is being transmitted to the entity that shared the COT, the responder UE may transmit the TB to the initiator UE using the resources associated with the COT. As a result, communication errors between the initiator UE and the responder UE may be decreased because the responder UE may not need to rely on less-accurate L1 logical IDs when performing Type 2 channel access, thereby reducing power, computing, and network resource consumption otherwise needed for correcting communication errors. Moreover, based at least in part on the mapping the logical ID associated with the TB to a global ID associated with the initiator UE, the responder UE may utilize Type 2 channel access across multiple communication sessions and/or cast types notwithstanding that the sessions/casts are associated with different logical IDs, thereby improving user experience, improving performance for latency-sensitive or delay-sensitive applications, and otherwise resulting in more efficient use of network resources.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

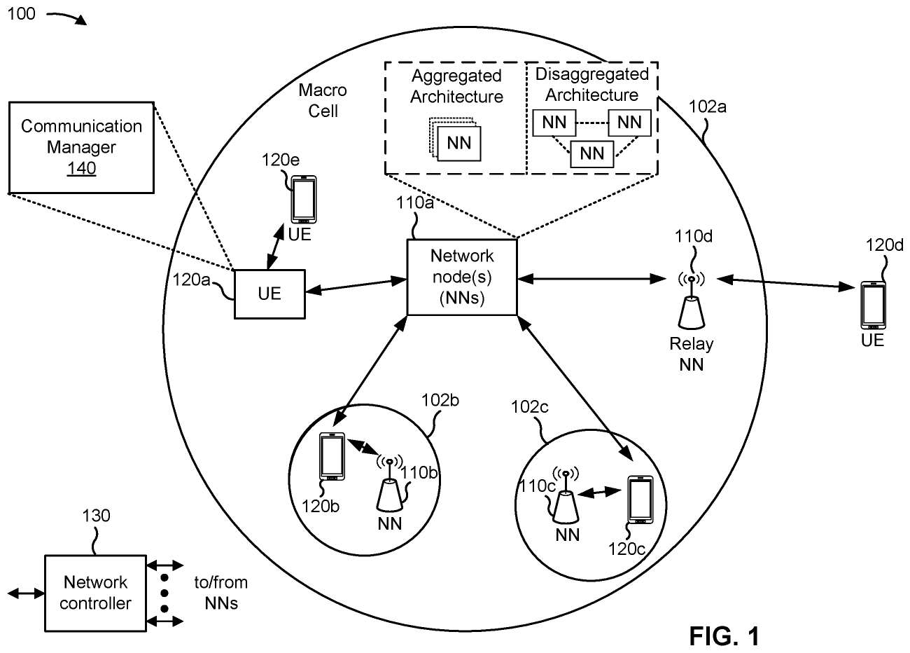

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHz-300 GHZ). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from an initiator UE, a COT-SI indicating resources associated with a COT; identify that the initiator UE is a target of a TB based at least in part on at least one of mapping a logical identifier associated with the TB to a global identifier associated with the initiator UE, or mapping the logical identifier associated with the TB to a logical identifier indicated by the COT-SI; and transmit the TB to the initiator UE using the resources associated with the COT based at least in part on identifying that the initiator UE is the target of the TB. Additionally, or alternatively, the communication manager 140 may perform one or more other operations described herein. Additionally, or alternatively, and as described in more detail elsewhere herein, the communication manager 140 may transmit, to a responder UE, a COT-SI indicating resources associated with a COT and at least one of a global identifier associated with the initiator UE, or one or more logical identifiers associated with the COT; and receive, from the responder UE, a TB using the resources associated with the COT based at least in part on at least one of a mapping of a logical identifier associated with the TB to the global identifier associated with the initiator UE, or a mapping of a logical identifier associated with the TB to a logical identifier indicated by the COT-SI. Additionally, or alternatively, the communication manager 140 may receive, from an initiator UE, a COT-SI indicating resources associated with a COT; identify that the initiator UE is a target of a TB based at least in part on mapping a link identifier associated with the TB to a logical identifier indicated by the COT-SI; and transmit the TB to the initiator UE using the resources associated with the COT based at least in part on identifying that the initiator UE is the target of the TB. Additionally, or alternatively, the communication manager 140 may transmit, to a responder UE, a COT-SI indicating resources associated with a COT and one or more logical identifiers associated with the COT; and receive, from the responder UE, a TB using the resources associated with the COT based at least in part on a mapping of a link identifier associated with the TB to a logical identifier indicated by the COT-SI. Additionally, or alternatively, the communication manager 140 may perform one or more other operations described herein.

As indicated above, FIG. 1 is provided as an example. Other examples may differ from what is described with regard to FIG. 1.

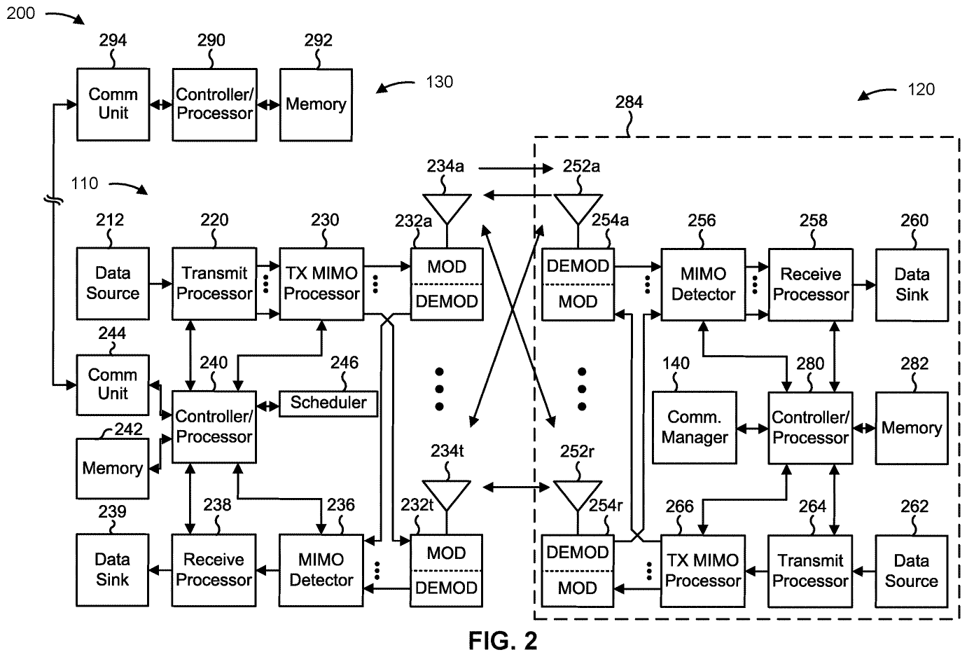

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

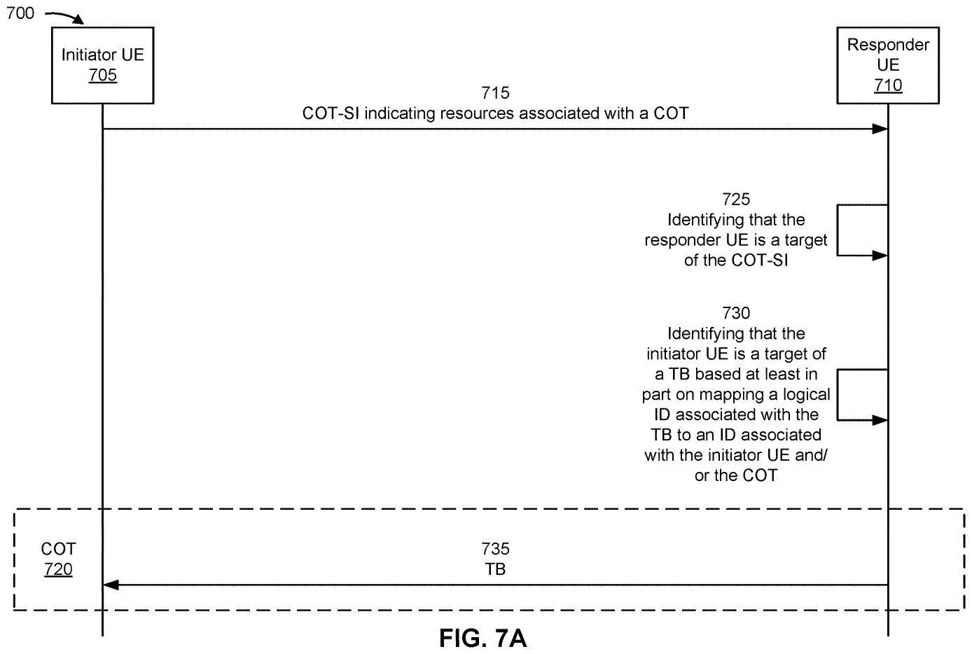

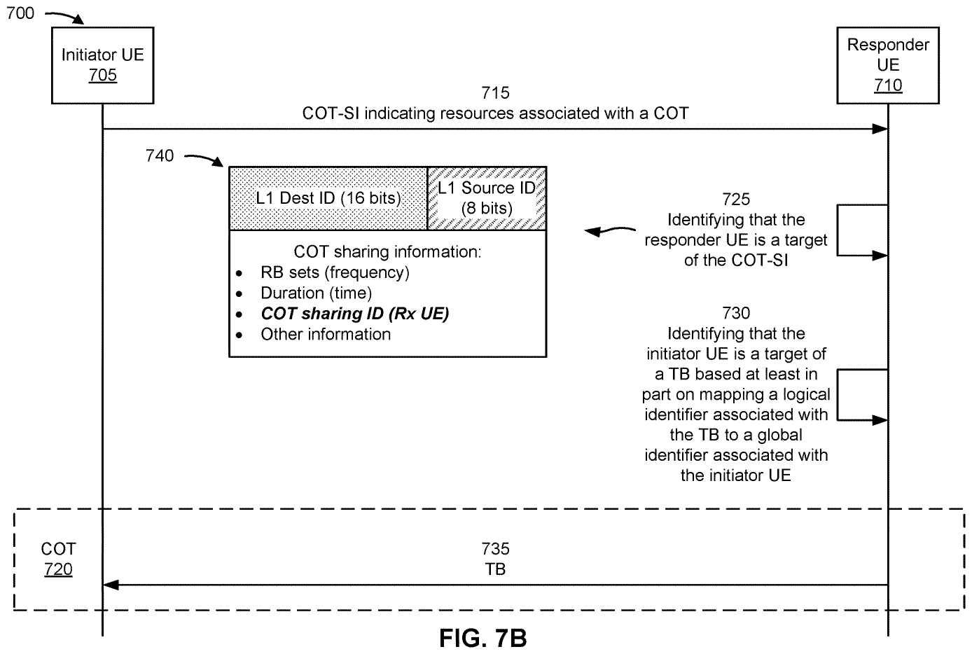

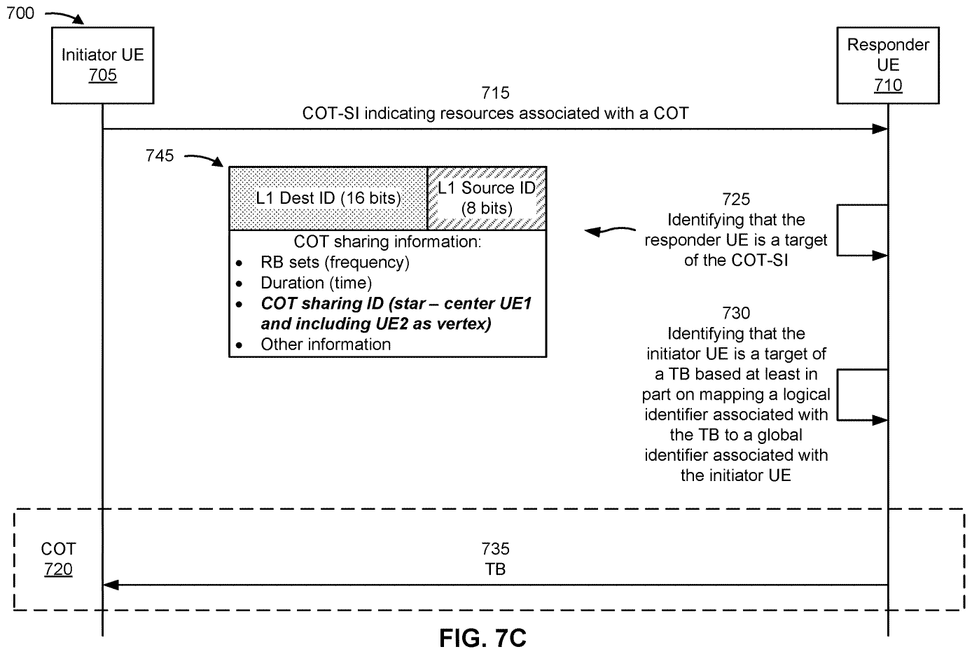

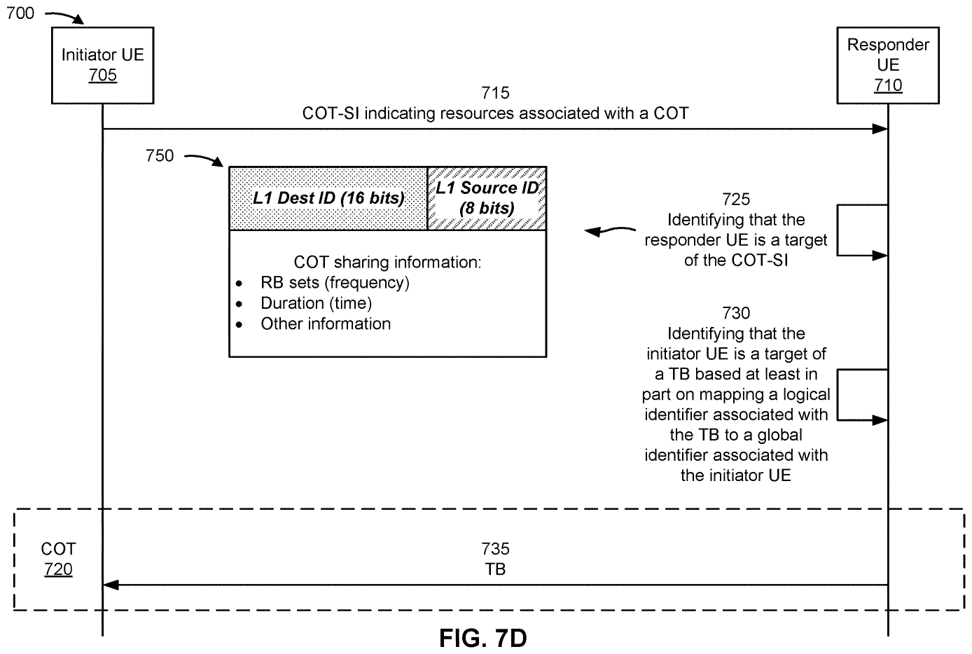

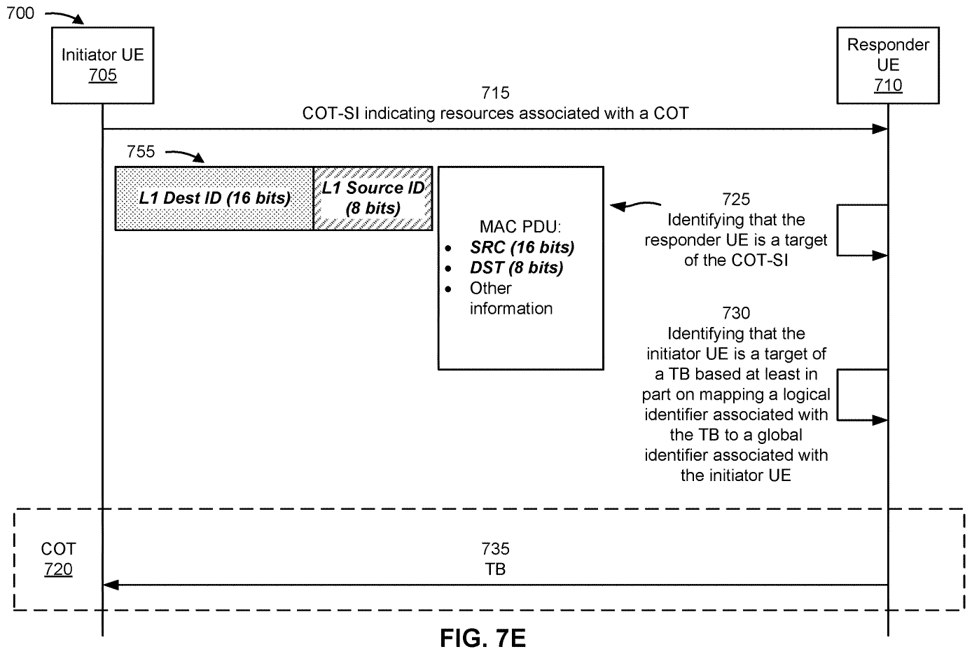

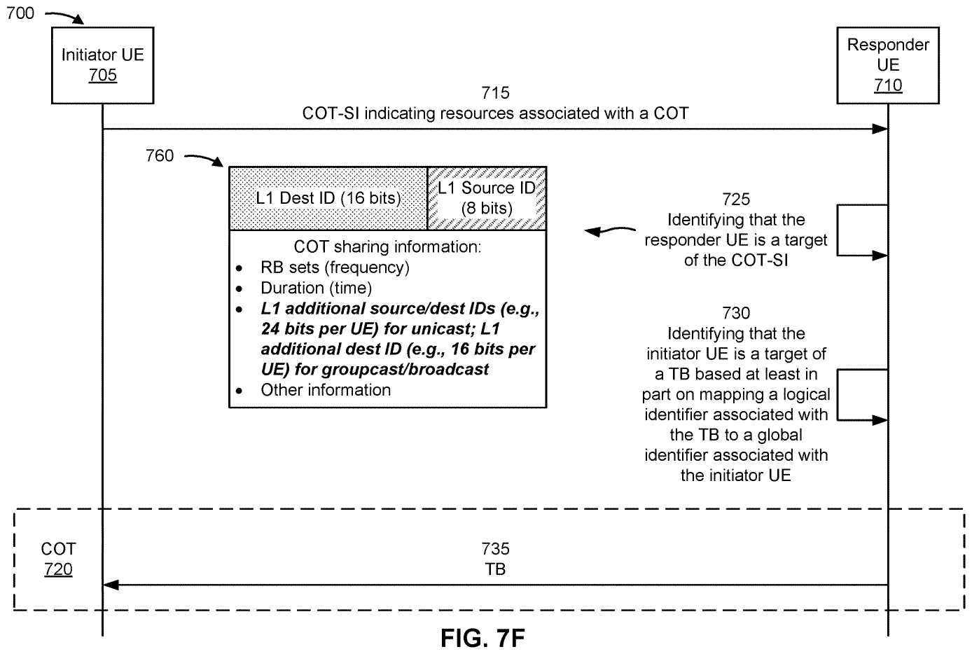

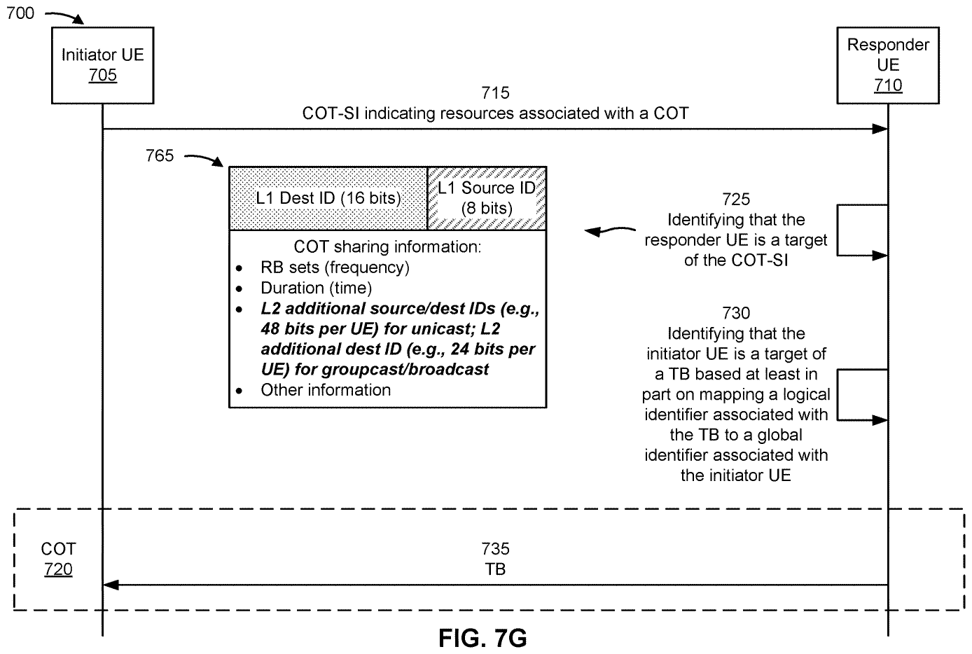

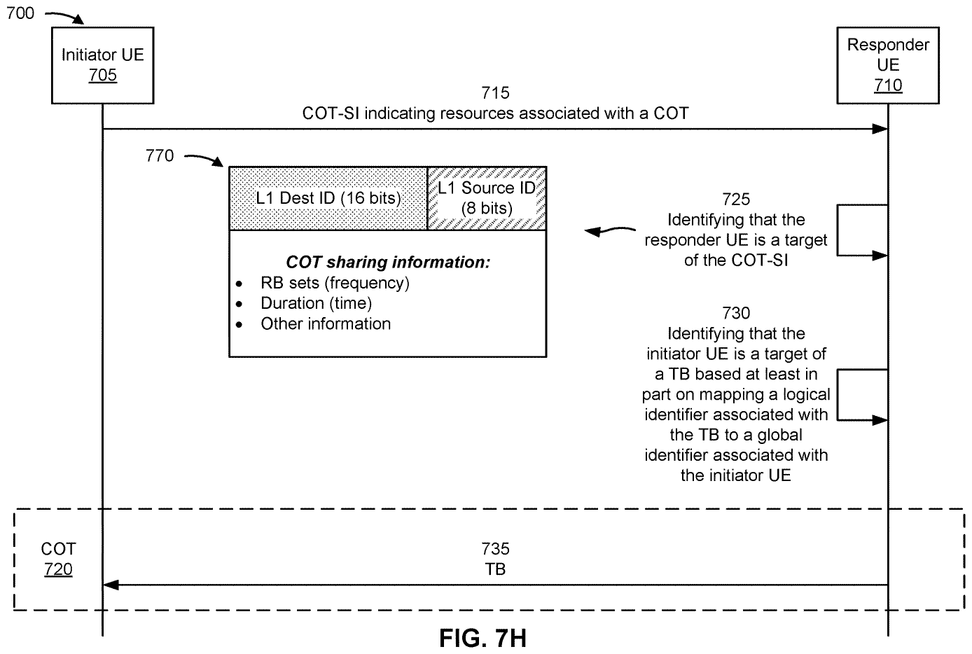

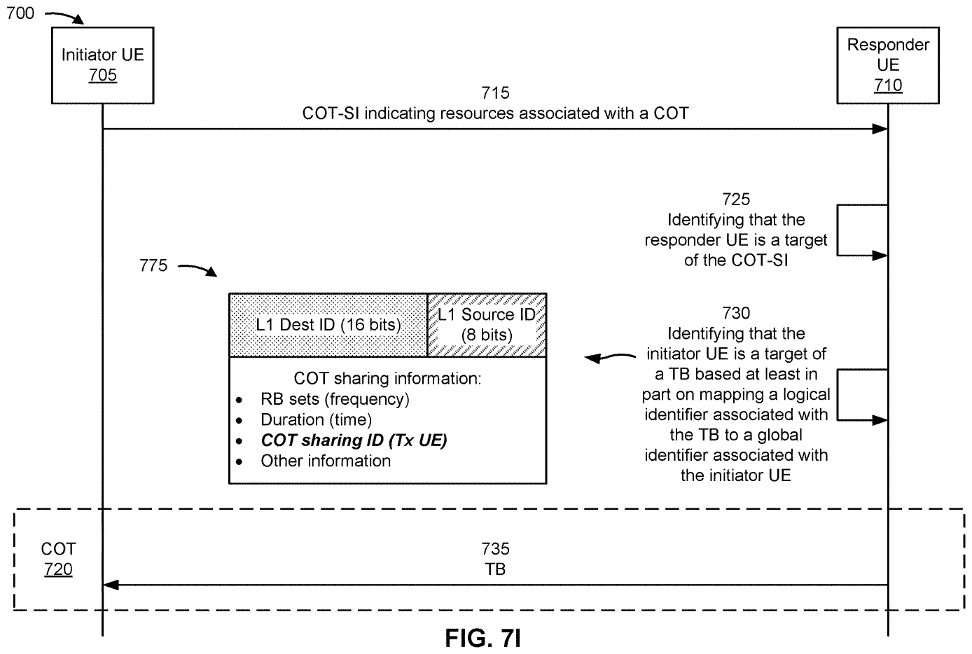

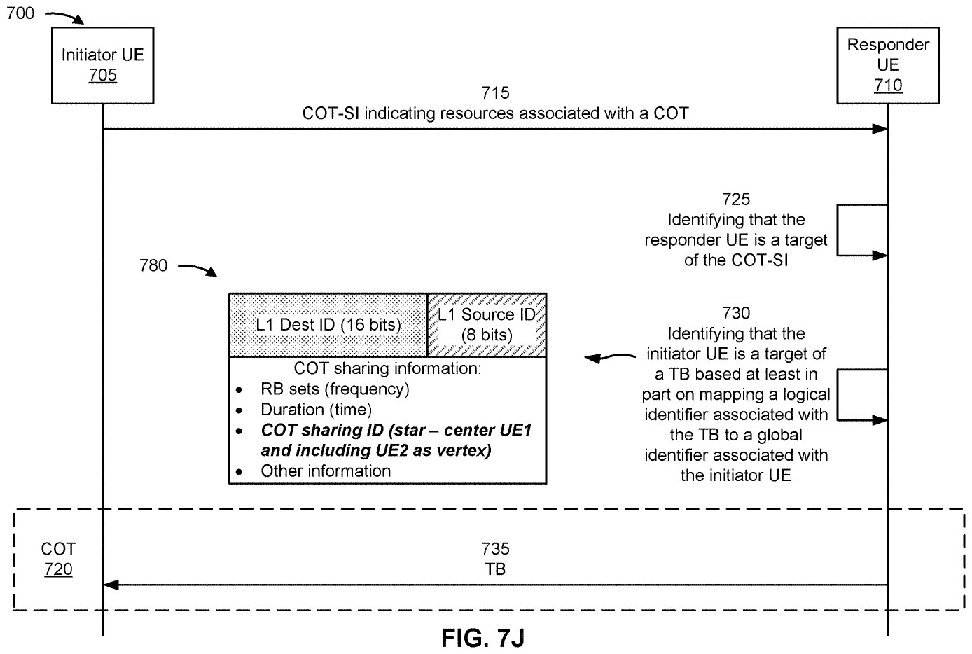

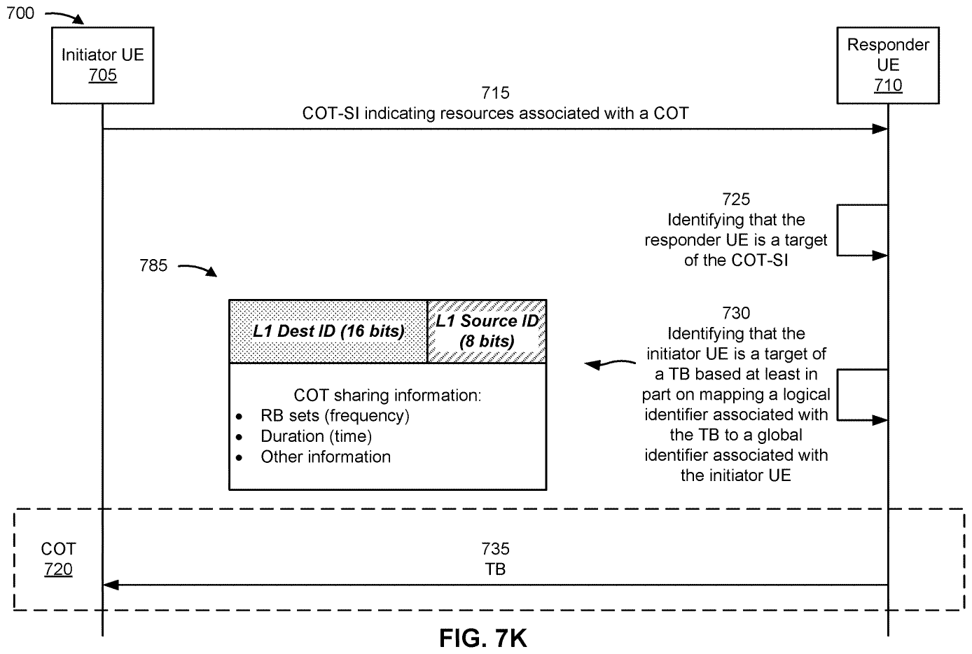

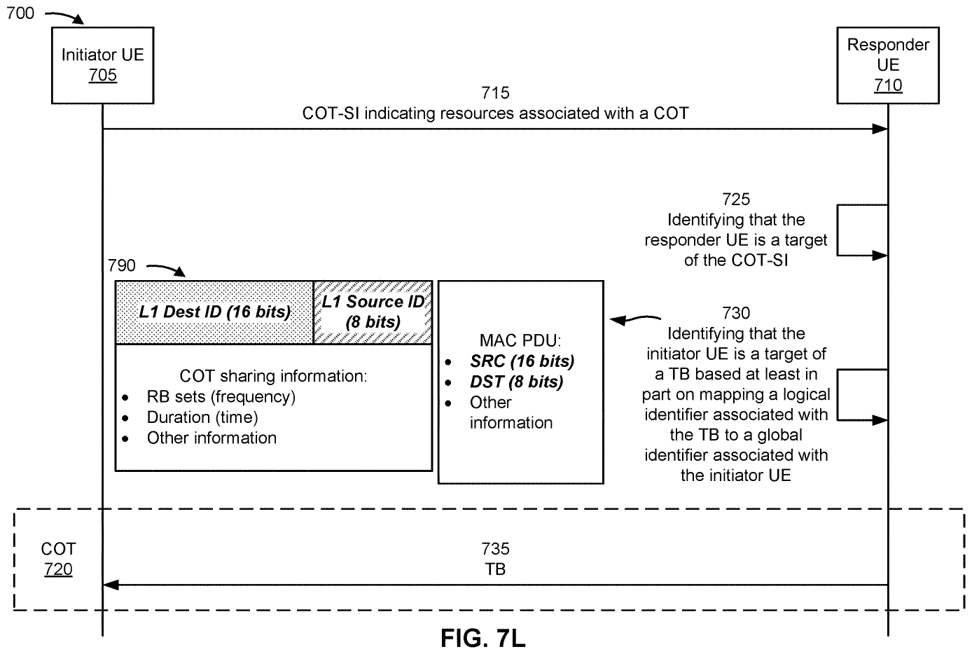

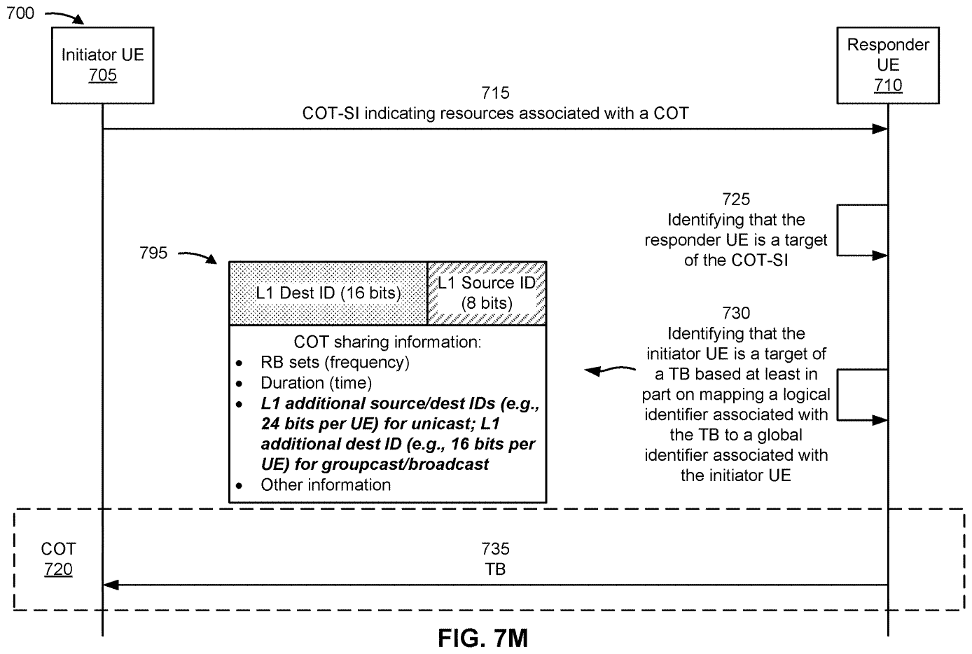

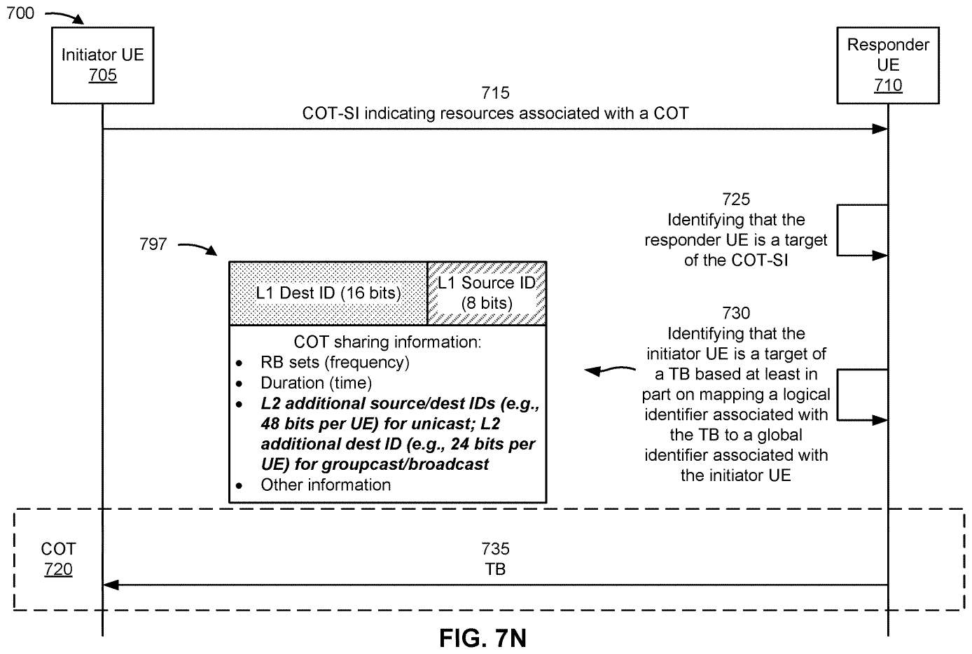

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-10).

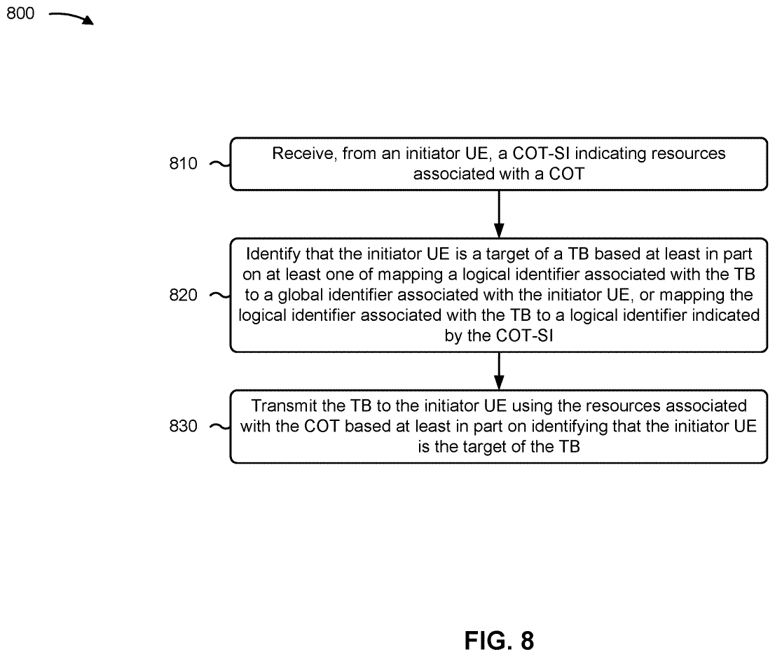

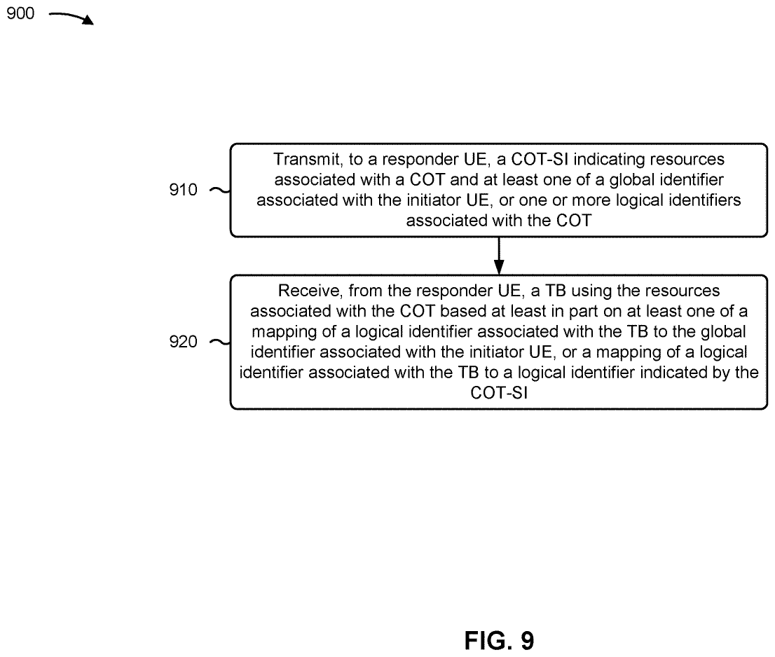

The controller/processor 240 of the network node 110, the controller/processor 280 of the UE 120, and/or any other component(s) of FIG. 2 may perform one or more techniques associated with using a shared COT across multiple sessions or casts, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 may correspond to a responder UE described elsewhere herein. The responder UE may include means for receiving, from an initiator UE, a COT-SI indicating resources associated with a COT; means for identifying that the initiator UE is a target of a TB based at least in part on at least one of: means for mapping a logical identifier associated with the TB to a global identifier associated with the initiator UE, or means for mapping the logical identifier associated with the TB to a logical identifier indicated by the COT-SI; and/or means for transmitting the TB to the initiator UE using the resources associated with the COT based at least in part on identifying that the initiator UE is the target of the TB.

The responder UE may include means for receiving, from an initiator UE, a COT-SI indicating resources associated with a COT; means for identifying that the initiator UE is a target of a TB based at least in part on mapping a link identifier associated with the TB to a logical identifier indicated by the COT-SI; and/or means for transmitting the TB to the initiator UE using the resources associated with the COT based at least in part on identifying that the initiator UE is the target of the TB. The means for the responder UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 may correspond to an initiator UE described elsewhere herein. The initiator UE may include means for transmitting, to a responder UE, a COT-SI indicating resources associated with a COT and at least one of a global identifier associated with the initiator UE, or one or more logical identifiers associated with the COT; and/or means for receiving, from the responder UE, a TB using the resources associated with the COT based at least in part on at least one of: a mapping of a logical identifier associated with the TB to the global identifier associated with the initiator UE, or a mapping of a logical identifier associated with the TB to a logical identifier indicated by the COT-SI. The initiator UE may include means for transmitting, to a responder UE, a COT-SI indicating resources associated with a COT and one or more logical identifiers associated with the COT; and/or means for receiving, from the responder UE, a TB using the resources associated with the COT based at least in part on a mapping of a link identifier associated with the TB to a logical identifier indicated by the COT-SI. The means for the initiator UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

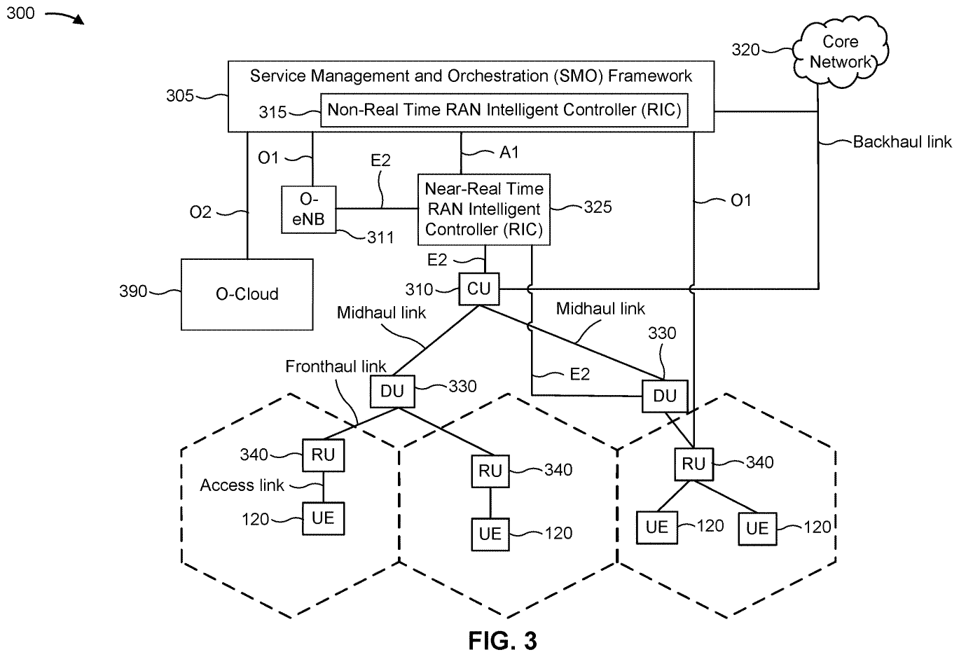

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high PHY layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

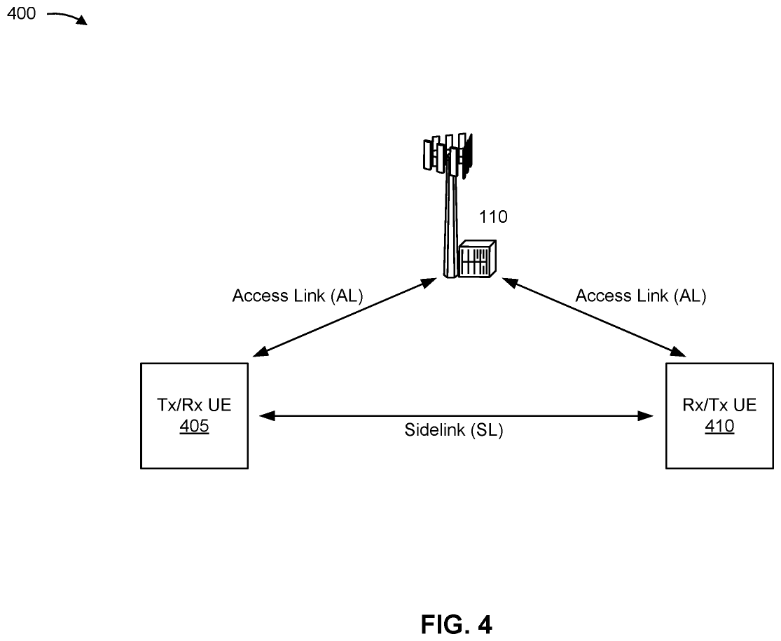

FIG. 4 is a diagram illustrating an example 400 of sidelink communications and access link communications, in accordance with the present disclosure.

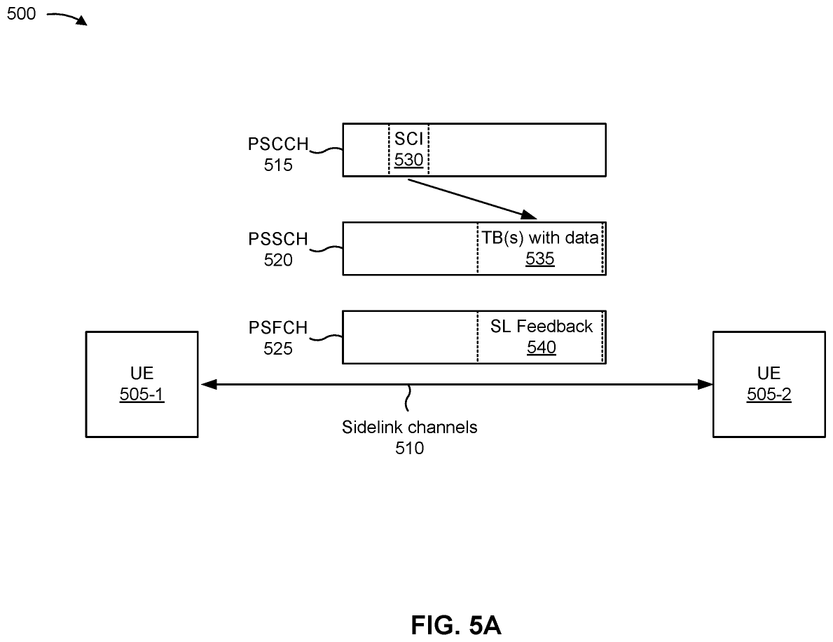

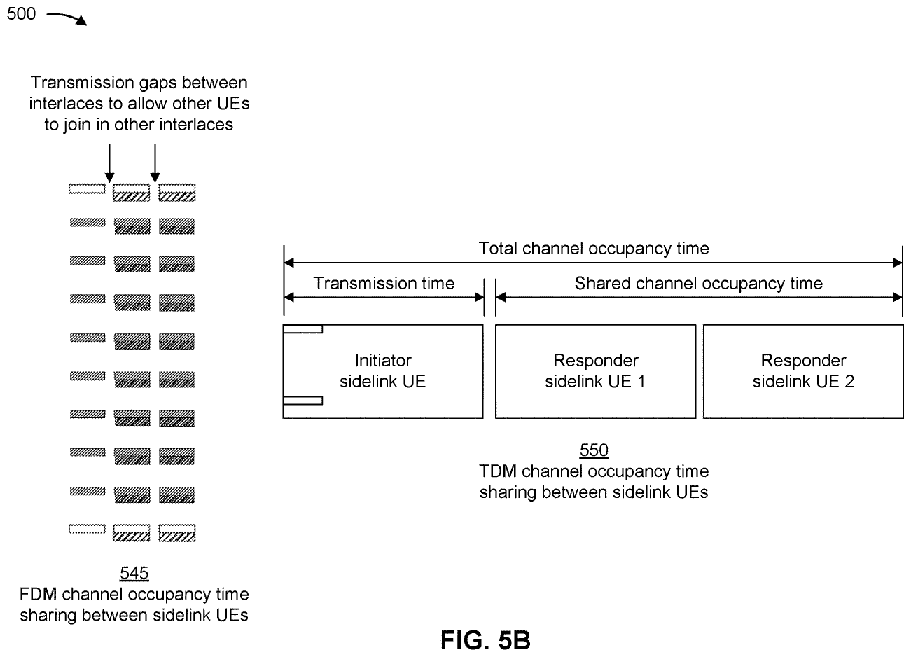

As shown in FIG. 4, a transmitter (Tx)/receiver (Rx) UE 405 and an Rx/Tx UE 410 may communicate with one another via a sidelink. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110). Aspects of channels that may be communicated via the sidelink are described in more detail below in connection with FIG. 5A.

As indicated above, FIG. 4 is provided as an example. Other examples may differ from what is described with respect to FIG. 4.

FIGS. 5A-5B are diagrams illustrating an example 500 of sidelink communications, in accordance with the present disclosure.

As shown in FIG. 5A, a first UE 505-1 may communicate with a second UE 505-2 (and one or more other UEs 505) via one or more sidelink channels 510. The first UE 505-1 and the second UE 505-2 may correspond to any of the UEs described herein, such as the UE 120 described above in connection with FIGS. 1-3, and/or the Tx/Rx UE 405 or the Rx/Tx UE 410 described above in connection with FIG. 4. The UEs 505-1 and 505-2 may communicate using the one or more sidelink channels 510 for P2P communications, D2D communications, V2X communications (e.g., which may include V2V communications, V2I communications, and/or V2P communications) and/or mesh networking. In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5A, the one or more sidelink channels 510 may include a PSCCH 515, a PSSCH 520, and/or a physical sidelink feedback channel (PSFCH) 525. The PSCCH 515 may be used to communicate control information, similar to a physical downlink control channel (PDCCH) and/or a physical uplink control channel (PUCCH) used for cellular communications with a network node 110 via an access link or an access channel. The PSSCH 520 may be used to communicate data, similar to a physical downlink shared channel (PDSCH) and/or a physical uplink shared channel (PUSCH) used for cellular communications with a network node 110 via an access link or an access channel. For example, the PSCCH 515 may carry sidelink control information (SCI) 530, which may indicate various control information used for sidelink communications, such as one or more resources (e.g., time resources, frequency resources, and/or spatial resources) where a TB 535 may be carried on the PSSCH 520. The TB 535 may include data. The PSFCH 525 may be used to communicate sidelink feedback 540, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 520, such as a HARQ process ID, a new data indicator (NDI), a source identifier, a destination identifier, a channel state information (CSI) report trigger, a COT-SI, or similar information.

In some aspects, the one or more sidelink channels 510 may use resource pools. For example, a scheduling assignment (e.g., included in SCI 530) may be transmitted in sub-channels using specific resource blocks (RBs) across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505 may operate using a sidelink transmission mode (e.g., Mode 1) where resource selection and/or scheduling is performed by a network node 110 (e.g., a base station, a CU, or a DU). For example, the UE 505 may receive a grant (e.g., in downlink control information (DCI) or in an RRC message, such as for configured grants) from the network node 110 (e.g., directly or via one or more network nodes) for sidelink channel access and/or scheduling. In some aspects, a UE 505 may operate using a transmission mode (e.g., Mode 2) where resource selection and/or scheduling is performed by the UE 505 (e.g., rather than a network node 110). In some aspects, the UE 505 may perform resource selection and/or scheduling by sensing channel availability for transmissions. For example, the UE 505 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy ratio (CBR) associated with various sidelink channels, which may be used for rate control (e.g., by indicating a maximum number of resource blocks that the UE 505 can use for a particular set of subframes).

In the transmission mode where resource selection and/or scheduling is performed by a UE 505, the UE 505 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message.

Furthermore, in some aspects, sidelink communications may be transmitted via the sidelink and/or access link communications may be transmitted via the access link in a licensed RF spectrum, an unlicensed RF spectrum, and/or any suitable combination thereof.

For example, to accommodate increasing traffic demands, there have been various efforts to improve spectral efficiency in wireless networks and thereby increase network capacity (e.g., via use of higher order modulations, advanced MIMO antenna technologies, multi-cell coordination techniques, and/or the like). Another way to potentially improve network capacity is to expand system bandwidth. However, available spectrum in lower frequency bands that have traditionally been licensed or otherwise allocated to mobile network operators may be limited.

Accordingly, various technologies have been developed to enable operation of a cellular RAT in unlicensed or other shared spectrum. For example, Licensed-Assisted Access (LAA) uses carrier aggregation on a downlink to combine LTE in a licensed frequency band with LTE in an unlicensed frequency band (e.g., the 2.4 and/or 5 GHz bands already populated by wireless local area network (WLAN) or “Wi-Fi” devices). In other examples, Enhanced LAA (eLAA) and Further Enhanced LAA (feLAA) technologies enable both uplink and downlink LTE operation in unlicensed spectrum, MulteFire is an LTE-based technology that operates in unlicensed and shared spectrum in a standalone mode, NR-U enables NR operation in unlicensed spectrum, and/or the like. In general, when operating a cellular RAT in unlicensed spectrum (e.g., using LAA, eLAA, feLAA, MulteFire, and/or NR-U), one challenge that arises is the need to ensure fair coexistence with incumbent (e.g., WLAN) systems that may be operating in the unlicensed spectrum.

For example, prior to gaining access to and/or transmitting over an unlicensed channel, a transmitting device (e.g., network node 110, UE 120, Tx/Rx UE 405, Rx/Tx UE 410, UE 505, and/or the like) may need to perform an LBT procedure to contend for access to the unlicensed channel. The LBT procedure may generally include a clear channel assessment (CCA) procedure that is performed in order to determine whether the unlicensed channel is available (e.g., unoccupied by other transmitters). In particular, the CCA procedure may include detecting an energy level on the unlicensed channel and determining whether the energy level satisfies (e.g., is less than or equal to) a threshold, sometimes referred to as an energy detection threshold and/or the like. When the energy level satisfies (e.g., does not equal or exceed) the threshold, the CCA procedure is deemed to be successful and the transmitting device may gain access to the unlicensed channel for a duration that may be referred to as a COT during which the transmitting device can perform transmissions without performing additional LBT operations. When the energy level does not satisfy the threshold, the CCA procedure is unsuccessful and contention to access the unlicensed channel may be deemed unsuccessful.

When the CCA procedure results in a determination that the unlicensed channel band is unavailable (e.g., because the energy level detected on the unlicensed channel indicates that another device is already using the channel), the CCA procedure may be performed again at a later time. In environments in which the transmitting device may obtain limited access to an unlicensed channel (e.g., due to WLAN activity or transmissions by other devices), an extended CCA (eCCA) procedure may be employed to increase the likelihood that the transmitting device will successfully obtain access to the unlicensed channel.

For example, a transmitting device performing an eCCA procedure may perform a random quantity of CCA procedures (from 1 to q), in accordance with an eCCA counter. If and/or when the transmitting device senses that the channel has become clear, the transmitting device may start a random wait period based on the eCCA counter and start to transmit if the channel remains clear over the random wait period.

Accordingly, although a wireless network can be configured to use unlicensed spectrum to achieve faster data rates, provide a more responsive user experience, offload traffic from a licensed spectrum, and/or the like, the need to ensure fair coexistence with incumbent systems (e.g., WLAN devices) may hamper efficient usage of the unlicensed spectrum. For example, even when there is no interference, the LBT procedure used to ensure that no other devices are already using the channel introduces a delay before transmissions can start, which may degrade user experience, result in unacceptable performance for latency-sensitive or delay-sensitive applications, and/or the like. Furthermore, these problems may be exacerbated when the initial CCA procedure is unsuccessful, as the transmitting device can transmit on the channel only after performing an additional quantity of CCA procedures and determining that the channel has become clear and remained clear for a random wait period. Furthermore, in some cases, the channel occupancy time obtained by a transmitting device may have a duration that is longer than necessary for the transmitting device to perform the desired transmissions, which may lead to inefficient usage of the unlicensed channel.

Accordingly, in some cases, a wireless network may enable a COT obtained by a transmitting device to be shared with other nodes in order to improve access, efficiency, and/or the like for an unlicensed channel. For example, in downlink-to-uplink channel occupancy time sharing over an access link, a network node 110 may acquire a COT with an eCCA, and the COT may be shared with one or more UEs (e.g., UE 120, Tx/Rx UE 405, Rx/Tx UE 410, UE 505, and/or the like) that can then transmit uplink signals within the COT acquired by the network node 110. In this case, a UE attempting to initiate an uplink transmission within the COT shared with the network node 110 can perform an uplink transmission without having to perform an LBT procedure, or the UE may perform the uplink transmission after performing a single-shot CCA with a shorter LBT procedure (e.g., a category 2 LBT procedure when the downlink-to-uplink gap duration is between 16 and 25 μs, a category 1 LBT procedure when a downlink-to-uplink gap duration is less than or equal to 16 μs, and/or the like).

Additionally, or alternatively, a wireless network may support uplink-to-downlink channel occupancy time sharing over an access link. In this case, a UE-initiated COT (e.g., for a configured grant PUSCH or a scheduled uplink transmission) can be shared with the network node 110. In this way, the network node 110 may be allowed to transmit control and/or broadcast signals and/or channels for any UE served by the network node 110, provided that the transmission contains a downlink signal, channel, and/or other transmission (e.g., a PDSCH, PDCCH, reference signal, and/or the like) intended to be received by the UE that initiated the channel occupancy.

Additionally, or alternatively, a wireless network may support UE-to-UE COT sharing over a sidelink. For example, as shown in FIG. 5B, and by reference number 545, a COT acquired by an initiator UE (e.g., Tx/Rx UE 405, UE 505-1, which may be a UE that initially performs a Type 1 channel access procedure to acquire a COT) may be shared in a frequency division multiplexing (FDM) mode by dividing the COT into multiple interlaces (e.g., time periods during which one or more UEs may perform transmit operations). For example, as shown in FIG. 5B, the initiator UE may use one or more sidelink resources (e.g., time and frequency resources) to transmit in a first interlace after the COT has been acquired, and a responder UE (e.g., Rx/Tx UE 410, UE 505-2) may use sidelink frequency resources that are non-overlapping with sidelink frequency resources used by the initiator UE to perform transmit operations in subsequent interlaces (e.g., the responder UE may respond using a Type 2 channel access procedure by sharing the COT acquired by the initiator UE). Accordingly, as shown in FIG. 5B, FDM or interlace-based COT sharing may introduce short transmission gaps between interlaces to allow other UEs to perform transmit operations in subsequent interlaces during a shared COT, and sidelink control information transmitted by the initiator UE may carry information to support the interlace-based COT sharing.

Additionally, or alternatively, as shown by reference number 550, UE-to-UE COT sharing may be enabled in a time division multiplexing (TDM) mode. In this case, the total COT may be divided into an initial time period during which the initiator UE may perform transmissions, which may include one or more sidelink control information transmissions that indicate when the initial transmission will end, a remaining duration of the COT that is available for sharing, and/or the like. Accordingly, one or more responder UEs may monitor the sidelink control information transmitted by other UEs (e.g., the initiator UE) to recover COT-SI that can be used to perform transmissions during a time period that corresponds to a shared COT (e.g., that can be used to enable to the responder UE to use a Type 2 channel access procedure).

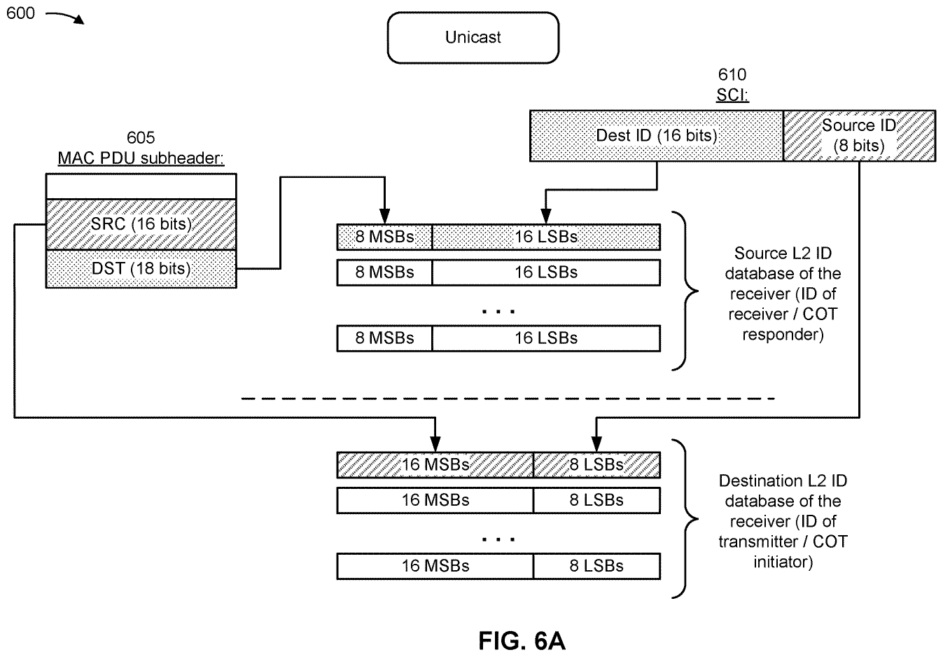

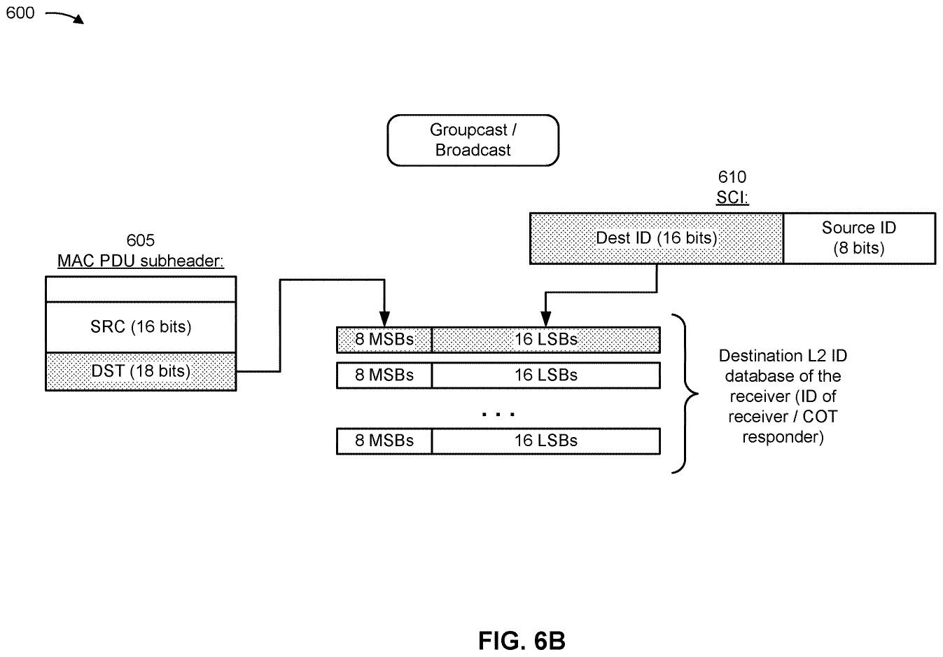

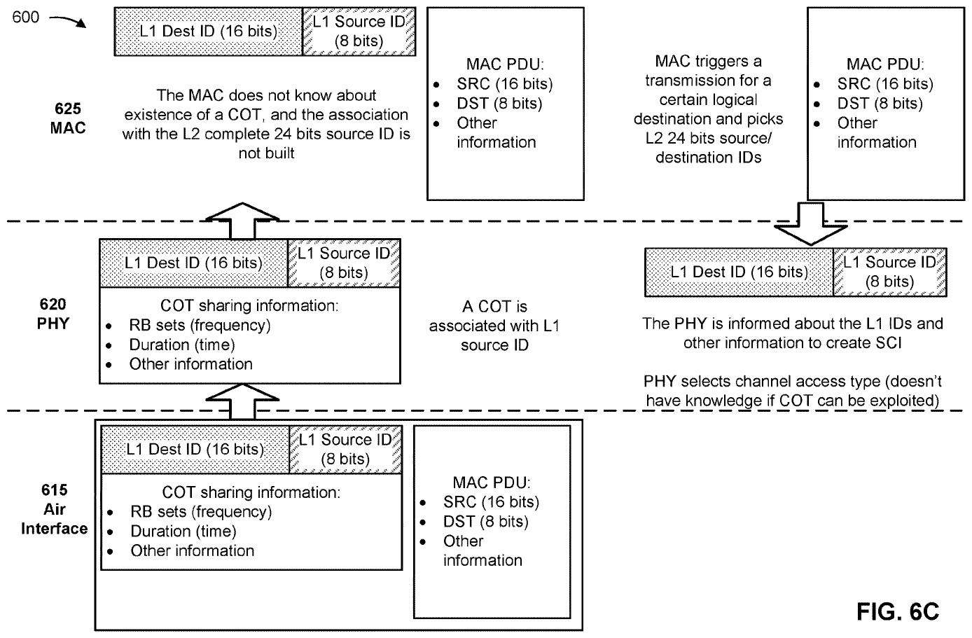

Accordingly, as described above, UE-to-UE UE sharing may enable better access to unlicensed spectrum, more efficient usage of unlicensed spectrum, and/or the like by enabling multiple UEs to perform transmissions during a UE that is obtained by an initiator UE (e.g., a UE that successfully performed an LBT procedure to acquire access to an unlicensed channel). Additional aspects of sidelink scheduling and resource selection, include the exchange of COT-SI, are described in more detail below in connection with FIGS. 6A-6C.

As indicated above, FIGS. 5A-5B are provided as an example. Other examples may differ from what is described with respect to FIGS. 5A-5B.

FIGS. 6A-6C are diagrams illustrating an example 600 associated with logical source and destination ID fields associated with a sidelink communication, in accordance with the present disclosure. The example 600 may be associated with a communication between UEs (e.g., Tx/Rx UE 405 and Rx/Tx UE 410 and/or UE 505-1 and UE 505-2) on the sidelink. In some aspects, the UEs may be included in a wireless network, such as wireless network 100. In some aspects, the UEs may communicate in an unlicensed spectrum (e.g., SL-U), as described above in connection with FIGS. 5A-5B.

In some examples, a UE that is a target of a data reception (e.g., a TB transmitted in a PSCCH 515 and/or a PSSCH 520) may be indicated by one or more logical IDs associated with an SCI associated with the data reception and/or a MAC packet data unit (PDU) subheader associated with the data reception. For example, as shown in FIG. 6A, if a TB is associated with a unicast transmission (e.g., a one-to-one transmission from one UE to another UE), a destination field (shown as “DST” field in FIG. 6A) of the decoded MAC PDU subheader 605 is equal to the 8 most significant bits (MSBs) of any of the source L2 ID(s) of the UE for which the 16 least significant bits (LSBs) are equal to the destination ID (shown as “Dest ID” in FIG. 6A) in the corresponding SCI 610, and the source field (shown as “SRC” field in FIG. 6A) of the decoded MAC PDU subheader 605 is equal to the 16 MSBs of any of the destination L2 ID(s) of the UE for which the 8 LSBs are equal to the source ID in the corresponding SCI 610. In that regard, for unicast transmissions, a receiver UE may check both the source ID and the destination ID to identify whether the receiver UE is the target of the data reception.

As shown in FIG. 6B, if a TB is associated with a groupcast transmission (e.g., a transmission between UEs belonging to a configured group of UEs) or a broadcast transmission (e.g., a transmission to any UEs configured to receive broadcast communications), the DST field of the decoded MAC PDU subheader 605 is equal to the 8 MSBs of any of the destination L2 ID(s) of the UE for which the 16 LSBs are equal to the destination ID (e.g., Dest ID) in the corresponding SCI 610. In that regard, for groupcast transmissions or broadcast transmissions, a receiver UE may only need to check a destination ID to identify whether the receiver UE is the target of the data reception.

For certain sidelink transmissions, a responder UE may only be permitted to use a shared COT (e.g., a COT indicated by an initiator UE via a COT-SI) if the transmission is intended for the initiator UE. For example, a wireless communication standard (e.g., a 3GPP standard) may only permit a responder UE to use a shared COT (e.g., use Type 2 channel access, instead of Type 1 channel access) for a PSCCH transmission and/or a PSSCH transmission if the PSCCH transmission and/or the PSSCH transmission is intended for initiator UE (e.g., the UE that indicated the shared COT). Put another way, when performing PSCCH/PSSCH transmissions, a responder UE may utilize a COT shared by a COT initiator UE (e.g., may use Type 2 channel access) at least when the responder UE's PSCCH/PSSCH transmission within RB sets corresponding to the shared COT is intended for the COT initiator UE (e.g., a unicast transmission to the initiator UE, a groupcast transmission including the initiator UE, and/or a broadcast transmission including the initiator UE).

In some examples, a PHY layer associated with the responder UE may verify whether a particular transmission can upgrade to Type 2 channel access (e.g., the PHY layer may determine COT sharing eligibility). However, although the PHY layer associated with the responder UE may have COT related information (e.g., RB sets associated with the COT, a channel access priority class (CAPC) associated with the COT, and similar information associated with the COT), the PHY layer may have access to only limited information associated with the ID of the initiator UE. More particularly, the PHY layer may only have access to the 8 bits in the source ID field in the SCI 610 corresponding to the 8 LSBs of the 24 bits L2 ID associated with a particular sidelink session, as described above in connection with FIG. 6A. Determining the permitted use of a Type 2 channel access based solely on this L1 information may be unreliable and/or lead to communication errors.

On the other hand, a MAC layer associated with the responder UE may have access to full L2 logical IDs related to sidelink sessions, and thus the MAC layer may be capable of reliably mapping a transmission to a logical destination. However, the MAC layer may not have access to L1 information related to a COT (e.g., COT-SI). More particularly, as shown in FIG. 6C, an initiator UE may transmit, and a responder UE may receive, a communication over an air interface 615. In some examples, the communication may include SCI indicating an L1 destination ID (e.g., the 16-bit L1 destination ID described above in connection with FIGS. 6A and 6B) and/or an L1 source ID (e.g., an 8-bit L1 source ID described above in connection with FIG. 6A). Moreover, the communication may include a COT-SI that indicates various information associated with a shared COT, such as RB sets associated with the shared COT, a duration of the shared COT, and/or other information associated with the shared COT. Moreover, the communication may include a MAC PDU subheader, which may indicate certain information such an SRC field (e.g., a 16-bit L2 source ID, as described above in connection with FIG. 6A), a DST field (e.g., an 8-bit L2 destination ID, as described above in connection with FIGS. 6A-6B), and/or other information associated with the MAC PDU.

In such examples, a PHY layer 620 associated with responder UE may maintain the COT information and/or may associate the COT information with the L1 logical IDs. Moreover, the PHY layer 620 may pass L2 information to a MAC layer 625 associated with the responder UE, but the PHY layer 620 may not pass the COT information to the MAC layer 625. In that regard, the MAC layer 625 may not have information regarding the existence of a shared COT, and thus the MAC layer 625 may not associate a complete 24-bit L2 source ID with the shared COT. Accordingly, when the MAC layer 625 triggers a transmission (e.g., a PSCCH transmission or a PSSCH transmission), the MAC layer 625 does not have information whether a shared COT may be utilized for the transmission. Instead, the MAC layer 625 may trigger a transmission for a certain logical destination and may select a 24-bit L2 source/destination ID associated with the transmission. The PHY layer 620 may be informed about the L1 logical IDs and other information needed to create SCI, but may be otherwise unaware of a device ID or a similar ID identifying the actual UE to which a transmission is being sent. Accordingly the PHY layer 620, which selects a channel access type for the transmission, does not have knowledge of whether a shared COT can be exploited for the transmission (e.g., the PHY layer 620 may not know if a destination includes the initiator UE). This is because the PHY layer 620 may not be capable of mapping the LI logical IDs to an actual device and thus the PHY layer 620 may not know if the transmission is being sent to a COT initiator UE.

Moreover, the above-described COT-sharing problem for certain sidelink transmissions (e.g., PSCCH/PSSCH transmissions) may become even more pronounced for transmissions spanning multiple communication sessions and/or cast types, for which logical IDs in both the MAC layer 625 and PHY layer 620 may change. More particularly, the IDs associated with the MAC layer 625 and/or the PHY layer 620 are logical IDs (e.g., per-session IDs), and thus are not mapped to a specific device (e.g., UE). Accordingly, the MAC layer 625 and the PHY layer 620 may not be able to determine if COT sharing is applicable to a new TB transmission by decoding a COT-SI from another link. Accordingly, in examples in which a responder UE may only use a shared COT for transmissions that include the COT initiator UE (e.g., a unicast transmission to the initiator UE, a groupcast transmission including the initiator UE, and/or a broadcast transmission including the initiator UE), segregation of information contained in the MAC layer (e.g., full L2 logical IDs) and information contained in the PHY layer (e.g., COT information) and/or transmitting communications using a new session and/or cast type may result in communication errors (and thus high power, computing, and network resource consumption for correcting communication errors), or else may require a responder UE to forgo Type 2 channel access altogether and perform Type 1 channel access, which may degrade user experience, result in unacceptable performance for latency-sensitive or delay-sensitive applications, and otherwise lead to inefficient use of network resources.

Some techniques and apparatuses described herein enable mapping a global ID associated with a COT initiator device and/or one or more logical IDs associated with a COT to a logical ID associated with a TB, thereby permitting a responder UE to identify whether a shared COT may be used for transmitting the TB. In some aspects, an initiator UE may transmit, and a responder UE may receive, a COT-SI indicating resources associated with a COT, one or more logical IDs associated with the COT, and/or one or more global IDs associated with the COT-SI and/or the initiator UE. When there is a TB associated with a logical ID to be transmitted by the responder UE (e.g., a TB to be transmitted by the responder UE using a communication session and/or cast type associated with the logical ID), the responder ID may map the logical ID to a global ID associated with the initiator UE and/or to a logical ID associated with the COT. Based at least in part on the mapping, which is indicative that the TB is being transmitted to the entity that shared the COT, the responder UE may transmit the TB to the initiator UE using the resources associated with the COT. As a result, communication errors between the initiator UE and the responder UE may be decreased, thereby reducing power, computing, and network resource consumption otherwise needed for correcting communication errors. Moreover, based at least in part on the mapping the logical ID associated with the TB to a global ID associated with the initiator UE, the responder UE may more readily utilize Type 2 channel access, which may improve user experience, improve performance for latency-sensitive or delay-sensitive applications, and otherwise result in more efficient use of network resources.

As indicated above, FIGS. 6A-6C are provided as an example. Other examples may differ from what is described with respect to FIGS. 6A-6C.

FIGS. 7A-7N is a diagram of an example 700 associated with using a shared COT across multiple sessions or casts, in accordance with the present disclosure. As shown in FIGS. 7A-7N, an initiator UE 705 (e.g., UE 120, Tx/Rx UE 405, UE 505-1) may communicate with a responder UE 710 (e.g., UE 120, Rx/Tx UE 410, UE 505-2). In some aspects, the initiator UE 705 and the responder UE 710 may be part of a wireless network (e.g., wireless network 100). The initiator UE 705 and the responder UE 710 may have established a wireless connection prior to operations shown in FIG. 7. For example, the initiator UE 705 and the responder UE 710 may have established a sidelink connection, such as a connection using the sidelink described above in connection with FIG. 4 and/or a connection using one or more of the sidelink channels 510 described above in connection with FIG. 5A. In some aspects, the initiator UE 705 and the responder UE 710 may be capable of communicating in an unlicensed spectrum (e.g., SL-U), such as by using the Type 1 channel access procedure and/or Type 2 channel access procedure described above in connection with FIGS. 5B-6C.

As shown in FIG. 7A, and as indicated by reference number 715, the initiator UE 705 may transmit, and the responder UE 710 may receive, a COT-SI indicating resources associated with a COT, such as a COT 720 shown in FIG. 7A, among other information. For example, as described above in connection with FIG. 6C, the COT-SI may indicate frequency resources associated with the COT 720 (e.g., RB sets associated with the COT 720), time resources associated with the COT 720 (e.g., a duration of the COT 720), and/or other information associated with the COT 720. In some aspects, the COT-SI may indicate one or more global IDs associated with the initiator UE 705 and/or one or more logical IDs associated with the COT 720, which is described in more detail below in connection with FIGS. 7B-7N.

As further shown in FIG. 7A, and as indicated by reference number 725, the responder UE 710 may identify that the responder UE 710 is a target of the COT-SI. For example, the responder UE 710 may identify that the responder UE 710 is a target of the COT-SI based at least in part on one or more IDs indicated by the COT-SI, which is described in more detail below in connection with FIGS. 7B-7G. Additionally, or alternatively, the responder UE 710 may identify that the responder UE 710 is a target of the COT-SI based at least in part on an ability of the responder UE 710 to decode the COT-SI, which is described in more detail below in connection with FIG. 7H.

As further shown in FIG. 7A, and as indicated by reference number 730, the responder UE 710 may identify that the initiator UE 705 is a target of a TB to be transmitted by the responder UE 710 based at least in part on mapping a logical identifier associated with the TB (e.g., a logical ID associated with a communication session and/or a cast being used to transmit the TB) to a global identifier associated with the initiator UE 705 and/or to a logical ID associated with the COT 720. In some aspects, the TB may be associated with one of a PSCCH communication or a PSSCH communication. Accordingly, based at least in part on a wireless communication standard (e.g., a 3GPP standard) or a similar rule, the responder UE 710 may only be permitted to use a Type 2 channel access procedure (e.g., may only be permitted to use a shared COT 720) if the COT initiator UE is an intended target of the TB. In that regard, in the operations shown in connection with reference number 730, the responder UE 710 may identify whether the initiator UE 705 is an intended target of the TB. If so (e.g., if a logical identifier associated with the TB maps to a global identifier associated with the initiator UE 705 and/or to a logical ID associated with the COT 720), the responder UE 710 may identify that Type 2 channel access (e.g., COT sharing) may be used for transmitting the TB, and thus transmit the TB to the initiator UE 705 using the COT 720, which is described in more detail below in connection with reference number 735. Conversely, if a logical identifier associated with the TB does not map to a global identifier associated with the initiator UE 705 and/or to a logical ID associated with the COT, the responder UE 710 may identify that Type 2 channel access (e.g., COT sharing) may be not used for transmitting the TB, and thus the responder UE 710 may utilize a Type 1 channel access procedure (e.g., may perform a LBT procedure) to reserve resources for transmitting the TB to the initiator UE 705.

In some aspects, the responder UE 710 may map a global identifier associated with the initiator UE 705 to multiple unicast, group, and/or broadcast logical identifiers associated with multiple sessions between the responder UE 710 and the initiator UE 705. In that way, if one session, of the multiple sessions, is used for purposes of transmitting the TB, the responder UE 710 may identify that the resources associated with the COT 720 may be used for the transmission. Additionally, or alternatively, in some aspects, the global identifier associated with the initiator UE 705 may be a COT sharing ID indicated by the COT-SI. According, for each of multiple sessions, the initiator UE 705 may transmit, and the responder UE 710 may receive, an indication of the COT sharing ID, and the responder UE 710 may maintain a mapping of the multiple session IDs to the COT sharing ID such that any of the multiple sessions may be later used to transmit a TB to the initiator UE using the shared COT 720. For example, the COT sharing ID may be a physical device ID associated with the initiator UE 705, or a similar ID, that is mapped to multiple logical IDs.

In some aspects, the responder UE 710 may maintain a mapping of the global ID and multiple logical IDs in one of a MAC layer associated with the responder UE 710 (e.g., MAC layer 625) or a PHY layer associated with the responder UE 710 (e.g., PHY layer 620). For example, in aspects in which the mapping of the global ID and the multiple logical IDs is maintained in the MAC layer associated with the responder UE 710, the MAC layer may identify whether the initiator UE 705 is the target of TB (e.g., by mapping the session and/or cast L2 logical ID associated with the TB to the global ID in the MAC layer). Similarly, in aspects in which the mapping of the global ID and the multiple logical IDs is maintained in the PHY layer associated with the responder UE 710, the PHY layer may identify whether the initiator UE 705 is the target of TB (e.g., by mapping the session and/or cast L1 logical ID associated with the TB to the global ID in the PHY layer). Additionally, or alternatively, in some aspects the logical ID associated with the TB is an L2 logical identifier but the PHY layer may perform the mapping of the logical ID to the global ID. In such aspects, the MAC layer may provide the L2 logical identifier to the PHY layer for the PHY layer to perform the mapping of the L2 logical identifier to the global ID associated with the initiator UE 705.

More particularly, in aspects in which a MAC layer determines COT sharing eligibility, a PHY layer may report a COT sharing region along with a COT initiator UE's ID(s) to the MAC layer, and the MAC layer may determine the COT sharing eligibility, accordingly. For example, based on the COT sharing region, L1/L2 logical ID(s) related to the TB, and a mapping of the L1/L2 logical IDs to a global ID associated with the initiator UE 705 (described in more detail below in connection with FIGS. 7I-7N), the MAC layer may determine COT sharing eligibility. More particularly, if the TB targets the COT initiator UE (e.g., the initiator UE 705), the MAC layer may indicate to the PHY layer that COT sharing is available (and thus Type 2 channel access may be used), and/or the MAC layer may explicitly indicate LBT type and, in some aspects, a common phase error (CPE) for gap control. In some other aspects, the PHY layer may determine COT sharing eligibility based on the COT sharing region, L1/L2 logical ID(s) related to the TB, and mapping the L1/L2 logical IDs to a global ID associated with the initiator UE 705 (described in more detail below in connection with FIGS. 7I-7N). In such aspects, the PHY layer may chose the LBT type and CPE, accordingly. Moreover, the PHY layer may perform the mapping using an L1 logical ID associated with the TB, or else using an L2 logical ID associated with the TB, which may be indicated to the PHY layer by the MAC layer (e.g., the MAC layer may indicate to the PHY layer the full L2 ID when scheduling a TB for transmission).

In some aspects, utilizing L2 logical IDs for purposes of mapping a logical ID to a global ID at the MAC layer may reduce communication errors (e.g., may increase mapping accuracy) because there is a reduced chance of misinterpreting a logical ID as more bits are used at L2 to identify a UE. However, a decoding process associated with L2 logical IDs may require more time and/or resource consumption that a decoding process associated with L1 logical IDs because the MAC PDU subheader may need to be decoded, as described above. On the other hand, utilizing L1 logical IDs for purposes of mapping a logical ID to a global ID at the PHY layer may reduce processing time, thus reducing a chance of losing the medium associated with the COT 720 due to other devices (e.g., UEs) jumping in and using the medium. However, using L1 logical IDs at the PHY layer may increase a chance of communication errors because less bits are used to identify a UE. However, a probability that two sets of L1 logical IDs that belong to different sessions and/or casts are the same may be relatively small.

In some aspects, signaling via a PC5-RRC connection (e.g., a logical connection between a pair of a source L2 ID and a destination L2 ID in the access stratum (AS)) associated with a unicast transmission may be used to perform the mapping. For example, a PC5-RRC connection for unicast logical links may be used to communication link-specific information (such as a COT sharing ID as an example of a global ID, which is described in more detail below). In that regard, unicast logical links and the associated L1/L2 unicast source/destination ID pairs may be grouped based on COT sharing IDs. This grouping may be useful for cross-session COT sharing, such as when a responder UE 710 needs to identify whether a unicast logical ID (e.g., a logical ID associated with a unicast session used to transmit a TB) is eligible to share the COT 720.

In that regard, the PC5-RRC connection may be used to communicate COT-sharing-group specific information (e.g., a global COT sharing ID) for unicast cross-session COT sharing. For example, from the perspective of the initiator UE 705 (e.g., the UE that creates the COT sharing ID), the COT sharing ID may identify a COT sharing group (e.g., all the unicast links (receiving UEs) that are targeted by the COT-SI). From the perspective of the responder UE 710 (e.g., the UE that received the COT sharing ID), the COT sharing ID may identify one or more unicast links with a given initiator UE 705 (e.g., the COT sharing ID may be used to determine whether the responder UE 710 itself is a target of the COT-SI and/or what unicast IDs may be used for response using the COT 720). In that regard, the responder UE 710 may not know whether the COT sharing ID was provided by the initiator UE 705 to other UEs (e.g., the responder UE 710 may not know whether other UEs are permitted to share the COT 720).

In some aspects, a mapping between a COT sharing ID and one or more logical IDs may be established via PC5-RRC signaling. For example, for each unicast RRC connection, a COT sharing ID may be exchanged (e.g., the mapping may be constructed by looking at all the unicast RRC connections related to L1/L2 source/destination ID pairs that were used to deliver the common COT sharing ID). In some aspects, each RRC unicast may have its own COT sharing ID, and/or the COT sharing ID may be a device ID associated with the initiator UE 705 (e.g., the initiator UE 705 may use its own device ID as the COT sharing ID).

For communications that do not include a PC5-RRC connection, such as groupcast communications and/or broadcast communications, group destination IDs may be created and managed at the application layer. In such aspects, grouping of group destination IDs (e.g., for purposes of cross-session COT sharing) may not be possible in RRC, and/or grouping unicast ID pairs with group destination IDs (with a common initiator UE 705, for cross-cast sharing) may not be possible in RRC. Accordingly, in some aspects, a destination group ID may be explicitly included in an initial transmission from the initiator UE 705 (e.g., a PSSCH transmission including the COT-SI). In some other aspects, a mapping may not be constructed in RRC but rather in SCI. For example, a COT sharing ID may be included in the COT-SI, and over time the responder UE 710 may associate the COT sharing ID with any other logical IDs (e.g., either unicast source/destination pair IDs or group destination IDs) included in the initiator UE 705's transmissions. This may permit for the responder UE 710 to perform cross-cast COT sharing (e.g., receiving COT-SI in one of a unicast communication, a groupcast communication, or a broadcast communication, and responding using a shared COT using a different one of a unicast communication, a groupcast communication, or a broadcast communication).

In some aspects, instead of, or in addition to, including a COT sharing ID in the COT-SI, the COT-SI may expressly indicate one or more logical IDs associated with the COT 720. For example, the COT-SI may include an additional IDs field that lists multiple logical identifiers associated with the COT 720, thereby broadening the scope of COT sharing (e.g., thereby enabling targeting of more UEs, sessions, and/or casts than are the target of the PSSCH carrying the COT-SI). In that regard, the COT-SI may include a field for one or more additional IDs (e.g., the COT sharing ID, logical IDs, or the like), indicating K additional IDs associated with the COT-SI (e.g., IDs in addition to the logical IDs indicated by the SCI and/or the MAC PDU subheader). In some aspects, the additional ID field may include 24 bits for each additional ID (e.g., K×24 bits). As described above, in aspects in the which the additional ID is a COT sharing ID, the COT sharing ID can point to (e.g., map to) a group of logical IDs associated with the shared COT 720. In aspects in which an ID (e.g., logical ID or COT sharing ID) is known to the responder UE 710, the responder UE 710 may be considered a target of the COT sharing, and thus may respond with a logical ID found in the COT-SI and/or a logical ID mapped to the COT sharing ID.

By mapping a global ID associated with the initiator UE to a logical ID associated with a TB, cross-session and/or cross-cast COT sharing may be enabled. For example, the responder UE 710 may receive, via a PSSCH communication from the initiator UE 705, the COT-SI via a unicast link and respond via a groupcast and/or broadcast link. In such aspects, the unicast link may include legacy source/destination unicast IDs (e.g., in SCI and MAC PDU header), as well as a COT-SI including one or more additional IDs. The one or more additional IDs may include logical IDs (e.g., L1/L2 group destination IDs) or a COT sharing ID that is mapped to many logical IDs (e.g., L1/L2 group destination IDs). In such aspects, the responder UE 710 may use the legacy logical IDs found in the PSSCH from the initiator UE 705 to respond to the initiator UE 705, the responder UE 710 may respond with a group L1/L2 destination ID found in the additional ID field of the COT-SI (if the responder UE 710 is part of the group associated with the group L1/L2 destination ID), and/or the responder UE 710 may respond using any logical ID (e.g., any other group L1/L2 destination ID) mapped to a COT sharing ID indicated by the COT-SI.

In some other aspects, the responder UE 710 may receive, via a PSSCH communication from the initiator UE 705, the COT-SI via a groupcast or broadcast link and respond via a unicast link. In such aspects, the groupcast or broadcast link may include legacy L1/L2 destination IDs (e.g., in SCI and/or a MAC PDU subheader), as well as a COT-SI including one or more additional IDs. The one or more additional IDs may include logical IDs (e.g., L1/L2 source/destination ID pairs) or a COT sharing ID that is mapped to many logical IDs (e.g., L1/L2 source/destination ID pairs). In such aspects, the responder UE 710, which may be one UE of a group of UEs targeted by the PSSCH, may use the legacy logical IDs found in the PSSCH from the initiator UE 705 to respond to the same group, the responder UE 710 may respond with an L1/L2 source/destination ID pair found in the additional ID field of the COT-SI, and/or the responder UE 710 may respond using any logical ID (e.g., any other L1/L2 source/destination ID pair) mapped to a COT sharing ID indicated by the COT-SI.

In some other aspects, the responder UE 710 may receive, via a PSSCH communication from the initiator UE 705, the COT-SI via a unicast link (sometimes referred to herein as an initial unicast link) and respond via a different unicast link. In such aspects, initial unicast link may include legacy L1/L2 source/destination ID pairs (e.g., in SCI and/or a MAC PDU subheader), as well as a COT-SI including one or more additional IDs. The one or more additional IDs may include logical IDs (e.g., L1/L2 source/destination ID pairs) or a COT sharing ID that is mapped to many logical IDs (e.g., L1/L2 source/destination ID pairs). In such aspects, the responder UE 710 may use the legacy logical IDs found in the PSSCH from the initiator UE 705 to respond to the initiator UE 705, the responder UE 710 may respond with an L1/L2 source/destination ID pair found in the additional ID field of the COT-SI, and/or the responder UE 710 may respond using any logical ID (e.g., any other L1/L2 source/destination ID pair) mapped to a COT sharing ID indicated by the COT-SI.

In some other aspects, the responder UE 710 may receive, via a PSSCH communication from the initiator UE 705, the COT-SI via a groupcast or broadcast link (sometimes referred to herein as an initial groupcast or broadcast link) and respond via a different groupcast or broadcast link. In such aspects, the initial groupcast or broadcast link may include legacy L1/L2 destination IDs (e.g., in SCI and/or a MAC PDU subheader), as well as a COT-SI including one or more additional IDs. The one or more additional IDs may include logical IDs (e.g., group L1/L2 destination IDs) or a COT sharing ID that is mapped to many logical IDs (e.g., group L1/L2 destination IDs). In such aspects, the responder UE 710 may use the legacy logical IDs found in the PSSCH from the initiator UE 705 to respond to the initiator UE 705, the responder UE 710 may respond with a group L1/L2 destination ID found in the additional ID field of the COT-SI, and/or the responder UE 710 may respond using any logical ID (e.g., any other group L1/L2 destination ID) mapped to a COT sharing ID indicated by the COT-SI.

Aspects of mapping global IDs to logical IDs, such as for purposes of cross-session and/or cross-cast COT sharing, are described in more detail below in connection with FIGS. 7B-7N.

In some aspects, the responder UE 710 may need to update the mapping of the global identifier and the multiple logical identifiers based at least in part on a logical identifier being changed to another logical identifier. For example, if one or more L2 logical IDs are updated (e.g., via PC5-RRC), the mapping between global IDs and the L2 logical IDs may be updated accordingly. Accordingly, when an upper layer changes an L2 logical ID associated with a session and/or a cast, the mapping between the global ID and logical IDs may be updated. In some aspects, the mapping between the global identifier and the multiple L2 logical identifiers may be updated via PC5-RRC, such as when updating an L2 logical ID associated with a unicast session (e.g., L2 source/destination ID pairs). In some other aspects, such as when a global ID is included in the COT-SI and one or more unicast logical IDs are included in a transmission (e.g., in an SCI (e.g., SCI 610), in a MAC PDU subheader (e.g., MAC PDU subheader 605), in a COT-SI, or in a similar data structure), the responder UE 710 may map the COT sharing ID or other global ID to the updated logical IDs included in the transmission (e.g., the COT sharing ID may be mapped to the logical IDs associated with unicasts between the initiator UE 705 and the responder UE 710). Aspects of mapping a global ID associated with the initiator UE 705 and a logical ID associated with a TB are described in more detail below in connection with FIGS. 7I-7N.

As further shown in FIG. 7A, and as indicated by reference number 735, the responder UE 710 may transmit, and the initiator UE 705 may receive, the TB using the resources associated with the COT 720 based at least in part on identifying that the initiator UE 705 is the target of the TB. Put another way, based at least in part on identifying that the TB is targeted to the UE which provided the COT-SI, the responder UE 710 may utilize Type 2 channel access procedures and thus transmit the TB using the shared COT 720, thereby reducing latency and resource consumption associated with sidelink communications between the responder UE 710 and the initiator UE 705. Aspects of identifying that the responder UE 710 is a target of the COT-SI (as described above in connection with reference number 725) are described in more detail below in connection with FIGS. 7B-7H, and aspects of identifying that the initiator UE 705 is a target of the TB are described in more detail below in connection with FIGS. 7I-7N.

As shown in FIG. 7B, and as indicated by reference number 740, in some aspects identifying that the responder UE 710 is the target of the COT-SI is based at least in part on a COT sharing ID indicated by the COT-SI. For example, in addition to indicating certain information associated with the COT 720, such as time and/or frequency resources, among other information, the COT-SI may include a COT sharing ID indicating that the COT-SI is intended for the responder UE 710. In aspects in which the COT 720 and/or the COT-SI is associated with a unicast communication, the COT sharing ID may be associated only with the initiator UE 705 and the responder UE 710. For example, the COT sharing ID may be a global ID linked only to the receiving UE (e.g., the responder UE 710 in the example shown in FIG. 7B), and, based at least in part on the COT-SI indicating the global ID associated with the responder UE 710, the responder UE 710 may identify that the COT-SI is intended for the responder UE 710 (e.g., the responder UE 710 may identify that the COT 720 is intended to be used by the responder UE 710). In some aspects, when a COT sharing ID is specific to a particular UE (e.g., when the COT sharing ID is associated with a unicast link), the COT sharing ID may be provided to a single UE (e.g., the responder UE) via PC5-RRC and/or via COT-SI.

In some other aspects, the COT 720 and/or the COT-SI may be associated with a groupcast communication and/or a broadcast communication. As shown in FIG. 7C, and as indicated by reference number 745, in such aspects the COT sharing ID may be associated with a group of UEs, with the responder UE 710 being associated with the group of UEs. For example, the COT sharing ID may be associated with a star-type data structure, indicating an ID associated with the initiator UE 705 at the center of the star-type data structure, and indicating an ID associated with the responder UE 710 as a vertex of the star-type data structure. In such aspects, each UE indicated at a vertex of the star-type data structure (which, in this example, includes the responder UE 710) may identify that the COT-SI is intended for the respective UE and that the COT 720 is intended to be used by the respective UE. In this regard, the COT sharing ID may be similar to a multilink ID associated with a number of links initiated by the initiator UE 705 and directed to a group of UEs (e.g., the UEs associated with the star-like data structure). Additionally, or alternatively, in such aspects, the COT sharing ID may be created by the initiator UE 705 and provided to multiple UEs (e.g., the responder UE 710 and other UEs in the group) via respective PC5-RRC links and/or respective COT-SIs.

As shown in FIG. 7D, and as indicated by reference number 750, in some aspects the responder UE 710 may identify that the responder UE 710 is a target of the COT-SI (and thus may properly use the COT 720) based at least in part on L1 logical IDs associated with the COT-SI. For example, the COT-SI may be associated with an LI destination ID (e.g., 16 bits) and an L1 source ID (e.g., 8 bits) pair for unicast communications, or an L1 destination ID (e.g., 16 bits) for groupcast or broadcast communications. In some aspects, if these L1 logical IDs are known to the responder UE 710, the responder UE 710 may identify that the responder UE 710 is a target of the COT-SI and thus can properly use the COT 720 for purposes of communications with the initiator UE 705.

As shown in FIG. 7E, and as indicated by reference number 755, in some aspects the responder UE 710 may identify that the responder UE 710 is a target of the COT-SI (and thus may properly use the COT 720) based at least in part on L2 logical IDs associated with an SCI and/or a MAC PDU subheader. For example, the MAC layer of the responder UE 710 may identify an L2 source ID (e.g., 24 bits) and an L2 destination ID (e.g., 24 bits) retrieved by SCI and the MAC PDU subheader in the case of unicast communications, and/or an L2 destination ID (e.g., 24 bits) retrieved by SCI and the MAC PDU subheader in the case of groupcast or broadcast communications (e.g., in the SCI, 16 bits may be associated with the destination ID and/or 8 bits may be associated with the source ID, and in the MAC PDU subheader, 16 bits may be associated with the SRC field and/or 8 bits may be associated with the DST field). In some aspects, if these L2 logical IDs are known to the responder UE 710, the responder UE 710 may identify that the responder UE 710 is a target of the COT-SI and thus can properly use the COT 720 for purposes of communications with the initiator UE 705.

As shown in FIGS. 7F and 7G, in some aspects, the COT-SI may expressly indicate one or more logical IDs that are targets of the COT-SI, such as by using an “additional IDs” field associated with the COT-SI or a similar field. More particularly, in some aspects, identifying that the responder UE 710 is the target of the COT-SI may be based at least in part on detecting a logical ID expressly indicated by an additional ID field of the COT-SI (e.g., a field that lists logical IDs in addition to the legacy logical IDs indicated by the SCI), such as an L1 logical ID (e.g., an L1 destination ID and/or L1 source ID), that is associated with the responder UE 710. For example, as shown in FIG. 7F, and as indicated by reference number 760, the COT-SI may expressly indicate one or more L1 logical IDs that are associated with the COT 720. For example, in aspects in which the COT-SI is associated with a unicast message, the COT-SI may expressly indicate one or more L1 source and destination ID pairs associated with the unicast message, such as by including 24 bits per intended UE, indicating L1 source/destination ID pairs associated with the UEs. Similarly, in aspects in which the COT-SI is associated with one of a groupcast message or a broadcast message, the COT-SI may expressly indicate one or more L1 destination IDs associated with the one of the groupcast message or the broadcast message, such as by including 16 bits per intended UE, indicating group L1 destination IDs associated with the UEs.

Similarly, as shown in FIG. 7G, and as indicated by reference number 765, the COT-SI may expressly indicate one or more L2 logical IDs that are associated with the COT 720. More particularly, in some aspects, identifying that the responder UE 710 is the target of the COT-SI may be based at least in part on detecting a logical identifier in an additional ID field of the COT-SI, such as an L2 logical ID, that is associated with the responder UE 710. For example, in aspects in which the COT-SI is associated with a unicast message, the COT-SI may expressly indicate one or more L2 source and destination ID pairs associated with the unicast message, such as by including 48 bits per intended UE, indicating L2 source/destination ID pairs associated with the UEs. Similarly, in aspects in which the COT-SI is associated with one of a groupcast message or a broadcast message, the COT-SI may expressly indicate one or more L2 destination IDs associated with the one of the groupcast message or the broadcast message, such as by including 24 bits per intended UE, indicating L2 destination IDs associated with the UEs.

As shown in FIG. 7H, and as indicated by reference number 770, in some aspects the responder UE 710 may identify that the responder UE 710 is the target of the COT-SI based at least in part on decoding the COT-SI. Put another way, in some aspects, decoding the COT-SI may be sufficient to declare that the receiving UE (in the example depicted in FIG. 7H, the responder UE 710) is the target of COT sharing.

As described above in connection with reference number 730, in some aspects the responder UE 710 may identify that the initiator UE 705 is a target of the TB based at least in part on mapping a logical ID associated with the TB to a global ID associated with the initiator UE 705 and/or to a logical ID associated with the COT 720. For example, in aspects in which a new TB is being unicast (and thus is associated with an L1/L2 logical source/destination ID pair), the responder UE 710 may re-use an L1/L2 source/destination ID pair found in the initial communication (e.g., the initial PSSCH) transmitted by the initiator UE 705 to the responder UE 710 (e.g., a legacy L1/L2 source/destination ID pair found in SCI and/or the MAC PDU subheader and/or an L1/L2 source/destination ID pair listed in an additional ID field of the COT-SI), and/or the responder UE 710 may use a mapping between L1/L2 source/destination IDs associated with unicasts to the initiator UE 705 and a global ID (e.g., a COT sharing ID) provided by the initiator UE 705 in in the initial communication. Moreover, in aspects in which a new TB is being groupcast or broadcast (and thus is associated with a group L1/L2 destination ID), the responder UE 710 may re-use a group L1/L2 destination ID found in the initial communication (e.g., the initial PSSCH) transmitted by the initiator UE 705 to the responder UE 710, and/or the responder UE 710 may use a mapping between group L1/L2 destination IDs associated with groupcasts or broadcasts to the initiator UE 705 and a global ID (e.g., a COT sharing ID) provided by the initiator UE 705 in in the initial communication.

More particularly, as shown in FIG. 7I, and as indicated by reference number 775, in some aspects the responder UE 710 may identify that the initiator UE 705 is a target of the TB based at least in part on mapping a logical identifier associated with the TB to a COT sharing ID indicated by the COT-SI (e.g., in some aspects, the global identifier described above in connection with reference number 730 may correspond to a COT sharing ID). More particularly, in addition to indicating certain information associated with the COT 720, such as time and/or frequency resources, among other information, the COT-SI may include the COT sharing ID indicating that the COT-SI and/or the COT 720 is associated with the initiator UE 705. In aspects in which the COT 720 and/or the COT-SI is associated with a unicast communication, the COT sharing ID may be associated only with the initiator UE 705 and the responder UE 710. For example, the COT sharing ID may be a global ID linked only to the transmitting UE (e.g., the initiator UE 705 in the example shown in FIG. 7I), and, based at least in part mapping a logical ID associated with the TB to the COT sharing ID, the responder UE 710 may identify the COT 720 is associated with the initiator UE 705 and thus may be used for transmitting the TB. In some aspects, the COT sharing ID described in connection with reference number 775 may be the same COT sharing ID described above in connection with the reference number 740 (e.g., the COT sharing ID may be used both for identifying that the responder UE 710 is a target of the COT-SI and for identifying that the initiator UE 705 is a target of a TB transmission). Additionally, or alternatively, in some aspects, the COT sharing ID may be provided to the responder UE 710 via a PC5-RRC link and/or via the COT-SI.

In some other aspects, the COT 720 and/or the COT-SI may be associated with a groupcast communication and/or a broadcast communication. As shown in FIG. 7J, and as indicated by reference number 780, in such aspects the COT sharing ID may be associated with a group of UEs, with the responder UE 710 being associated with the group of UEs. For example, the COT sharing ID may be associated with a star-type data structure, indicating an ID associated with the initiator UE 705 at the center of the star-type data structure, and indicating an ID associated with the responder UE 710 as a vertex of the star-type data structure. Put another way, the COT sharing ID in this aspect may be similar to a multilink ID indicating multiple links started by the initiator UE 705 and directed to a group of UEs that includes the responder UE 710. In such aspects, each UE indicated at a vertex of the star-type data structure (which, in this example, includes the responder UE 710) may identify that the COT-SI is intended for the respective UE and/or that the COT 720 is intended to be used by the respective UE for transmitting TBs to the UE at the center of star-type data structure (e.g., the initiator UE 705). In some aspects, the COT sharing ID described in connection with reference number 780 may be the same COT sharing ID described above in connection with the reference number 745 (e.g., the COT sharing ID may be used both for identifying that the responder UE 710 is a target of the COT-SI and for identifying that the initiator UE 705 is a target of a TB transmission). Additionally, or alternatively, in some aspects, the COT sharing ID may be created by the initiator UE 705 and provided to multiple UEs (e.g., each UEs of the group of UEs, which includes the responder UE 710 in this example) via respective PC5-RRC links and/or via respective COT-SIs.

As shown in FIG. 7K, and as indicated by reference number 785, in some aspects the responder UE 710 may identify that the initiator UE 705 is a target of the TB (and thus the TB may be properly transmitted using the COT 720) based at least in part on L1 logical IDs associated with the COT-SI. For example, the COT-SI may be associated with an L1 destination ID (e.g., 16 bits) and an L1 source ID (e.g., 8 bits) pair for unicast communications, or an L1 destination ID (e.g., 16 bits) for groupcast or broadcast communications. In some aspects, these L1 logical IDs may be mapped to a global ID (e.g., a device ID) associated with the initiator UE 705, such as within the PHY layer at the responder UE 710. Accordingly, when transmitting the TB, if a logical ID associated with the TB is mapped to a global ID associated with the initiator UE 705, the responder UE 710 may identify that the initiator UE 705 is a target of the TB and thus the TB may be properly transmitted using the COT 720.

As shown in FIG. 7L, and as indicated by reference number 790, in some aspects the responder UE 710 may identify that the initiator UE 705 is a target of the TB (and thus the TB may properly be transmitted using the COT 720) based at least in part on L2 logical IDs associated with an SCI and/or a MAC PDU subheader. For example, the MAC layer of the responder UE 710 may identify an L2 source ID (e.g., 24 bits) and an L2 destination ID (e.g., 24 bits) retrieved by SCI and the MAC PDU subheader in the case of unicast communications, and/or an L2 destination ID (e.g., 24 bits) retrieved by SCI and the MAC PDU subheader in the case of groupcast or broadcast communications (e.g., in the SCI, 16 bits may be associated with the destination ID and/or 8 bits may be associated with the source ID, and in the MAC PDU subheader, 16 bits may be associated with the SRC field and/or 8 bits may be associated with the DST field). In some aspects, these L2 logical IDs may be mapped to a global ID (e.g., a device ID) associated with the initiator UE 705, such as within the MAC layer at the responder UE 710. Accordingly, if a L2 logical ID associated with the TB is mapped to the global ID (e.g., device ID) associated with the initiator UE 705, the responder UE 710 may identify that the initiator UE 705 is a target of the TB and thus the TB may be properly transmitted using the COT 720.

As shown in FIGS. 7M and 7N, in some aspects, the COT-SI may expressly indicate one or more logical IDs that are associated with the COT-SI (e.g., one or more sessions or casts that may use the COT 720), such as by using an “additional IDs” field associated with the COT-SI or a similar field. For example, as shown in FIG. 7M, and as indicated by reference number 795, the COT-SI may expressly indicate one or more L1 logical IDs of sessions and/or casts that may use the COT 720. For example, in aspects in which the COT-SI is associated with a unicast message, the COT-SI may expressly indicate one or more L1 source and destination ID pairs associated with the unicast message, such as by including 24 bits per intended UE, indicating L1 source/destination ID pairs associated with the UEs. Similarly, in aspects in which the COT-SI is associated with one of a groupcast message or a broadcast message, the COT-SI may expressly indicate one or more L1 destination IDs associated with the one of the groupcast message or the broadcast message, such as by including 16 bits per intended UE, indicating L1 destination IDs associated with the UEs. Accordingly, the responder UE 710 may determine that the COT 720 may be used to transmit the TB when using a session associated with one of the one or more L1 source and destination ID pairs indicated by the COT-SI.

Similarly, as shown in FIG. 7N, and as indicated by reference number 797, the COT-SI may expressly indicate one or more L2 logical IDs that are associated with the COT 720 (e.g., one or more sessions or casts that may use the COT 720). For example, in aspects in which the COT-SI is associated with a unicast message, the COT-SI may expressly indicate one or more L2 source and destination ID pairs associated with the unicast message, such as by including 48 bits per intended UE, indicating L2 source/destination ID pairs associated with the UEs. Similarly, in aspects in which the COT-SI is associated with one of a groupcast message or a broadcast message, the COT-SI may expressly indicate one or more L2 destination IDs associated with the one of the groupcast message or the broadcast message, such as by including 24 bits per intended UE, indicating L2 destination IDs associated with the UEs. Accordingly, the responder UE 710 may determine that the COT 720 may be used to transmit the TB when using a session associated with one of the one or more L2 destination IDs indicated by the COT-SI.

In aspects in which the a COT-SI expressly indicates one or more IDs associated with the COT 720 (such as aspects in which the COT-SI includes a COT sharing ID as described above in connection with FIGS. 7B-7C and 7I-7J and/or aspects in which the COT-SI includes L1 and/or L2 logical IDs as described above in connection with FIGS. 7F-7G and 7M-7N), the COT-SI may include an additional ID field indicating one or more IDs (e.g., one or more of a COT sharing ID, a group destination ID, and/or a unicast source and destination ID pair). In some aspects, the COT-SI may further indicate whether an ID associated with the additional ID field is the COT sharing ID based at least in part on an indicator associated with the ID. For example, each ID included in the additional IDs field may include a one-bit indication per ID indicating whether the corresponding ID is a COT sharing ID (e.g., one of bit “1” or bit “0” may indicate that the corresponding ID is the COT sharing ID, and the other one of bit “1” or bit “0” may indicate that the corresponding ID is not the COT sharing ID and thus is a logical ID). Additionally, or alternatively, in some aspects, the COT-SI may indicate whether an ID associated with the additional IDs field is the COT sharing identifier based at least in part on whether the ID is associated with a string of zero bits. For example, in aspects in which the COT sharing ID is shorter than other IDs included in the additional IDs field (e.g., L1 logical IDs and/or L2 logical IDs), such as when the COT sharing ID is K bits shorter than other IDs included in the additional IDs field, the first or last K bits of the bits associated with the COT sharing ID may be zero bits, indicating that the ID is a COT sharing ID. Put another way, in some aspects, the responder UE 710 may identify that an ID is a COT sharing ID based at least in part on the responder UE 710 detecting a fixed number of zeros in the head or tail of bits associated with the COT sharing ID.

Based at least in part on initiator UE 705 and the responder UE 710 communicating by mapping logical IDs associated with a TB to a global ID associated with the initiator UE 705 and/or to a logical ID associated with the COT 720, the UEs 705, 710 may conserve computing, power, network, and/or communication resources that may have otherwise been consumed traditional channel access and sidelink communication procedures. For example, based at least in part on initiator UE 705 and the responder UE 710 communicating by mapping logical IDs associated with a TB to a global ID associated with the initiator UE 705 and/or to a logical ID associated with the COT 720, the UEs 705, 710 may communicate with a reduced error rate, which may conserve computing, power, network, and/or communication resources that may have otherwise been consumed to detect and/or correct communication errors, and/or may utilize Type 2 channel access procedures across various sessions and cast types, thereby reducing latency and resource consumption associated with sidelink communications.

As indicated above, FIGS. 7A-7N are provided as examples. Other examples may differ from what is described with respect to FIGS. 7A-7N.

FIG. 8 is a diagram illustrating an example process 800 performed, for example, by a responder UE, in accordance with the present disclosure. Example process 800 is an example where the responder UE (e.g., responder UE 710) performs operations associated with using a shared COT across multiple sessions or casts.

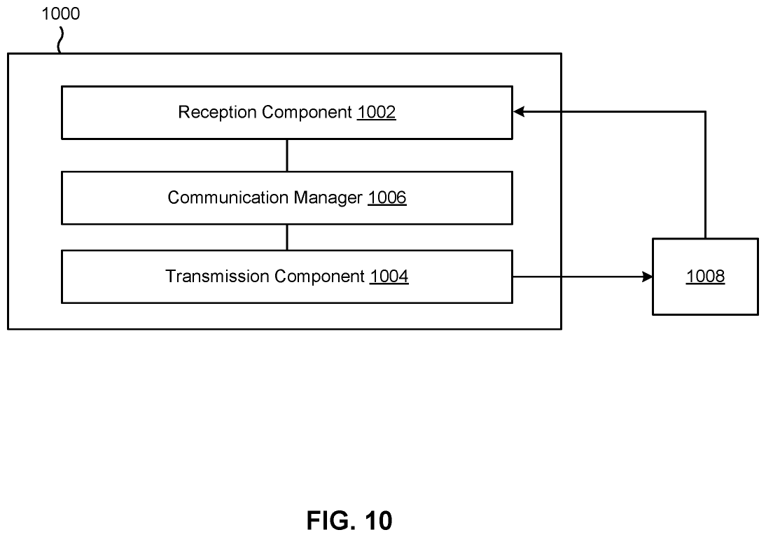

As shown in FIG. 8, in some aspects, process 800 may include receiving, from an initiator UE, a COT-SI indicating resources associated with a COT (block 810). For example, the responder UE (e.g., using reception component 1002 and/or communication manager 1006, depicted in FIG. 10) may receive, from an initiator UE, a COT-SI indicating resources associated with a COT, as described above.

As further shown in FIG. 8, in some aspects, process 800 may include identifying that the initiator UE is a target of a TB based at least in part on at least one of: mapping a logical identifier associated with the TB to a global identifier associated with the initiator UE, or mapping the logical identifier associated with the TB to a logical identifier indicated by the COT-SI (block 820). For example, the responder UE (e.g., using communication manager 1006, depicted in FIG. 10) may identify that the initiator UE is a target of a TB based at least in part on at least one of: mapping a logical identifier associated with the TB to a global identifier associated with the initiator UE, or mapping the logical identifier associated with the TB to a logical identifier indicated by the COT-SI, as described above.

As further shown in FIG. 8, in some aspects, process 800 may include transmitting the TB to the initiator UE using the resources associated with the COT based at least in part on identifying that the initiator UE is the target of the TB (block 830). For example, the responder UE (e.g., using transmission component 1004 and/or communication manager 1006, depicted in FIG. 10) may transmit the TB to the initiator UE using the resources associated with the COT based at least in part on identifying that the initiator UE is the target of the TB, as described above.

Process 800 may include additional aspects, such as any single aspect or any combination of aspects described below and/or in connection with one or more other processes described elsewhere herein.

In a first aspect, process 800 includes identifying that the responder UE is a target of the COT-SI, wherein transmitting the TB to the initiator UE using the resources associated with the COT is further based at least in part on identifying that the responder UE is the target of the COT-SI.

In a second aspect, alone or in combination with the first aspect, process 800 includes identifying that the responder UE is the target of the COT-SI based at least in part on a COT sharing identifier indicated by the COT-SI.

In a third aspect, alone or in combination with one or more of the first and second aspects, the COT sharing identifier is associated only with the initiator UE and the responder UE.

In a fourth aspect, alone or in combination with one or more of the first through third aspects, the COT sharing identifier is associated with a group of UEs, and the responder UE is associated with the group of UEs.

In a fifth aspect, alone or in combination with one or more of the first through fourth aspects, process 800 includes identifying that the responder UE is the target of the COT-SI based at least in part on detecting a logical identifier in the COT-SI that is associated with the responder UE.

In a sixth aspect, alone or in combination with one or more of the first through fifth aspects, the logical identifier in the COT-SI is associated with one of a layer 1 source and destination identifier pair associated with a unicast message, or a layer 2 source and destination identifier pair associated with the unicast message.

In a seventh aspect, alone or in combination with one or more of the first through sixth aspects, the logical identifier in the COT-SI is associated with one of a layer 1 destination identifier associated with one of a groupcast message or a broadcast message, or a layer 2 destination identifier associated with the one of the groupcast message or the broadcast message.

In an eighth aspect, alone or in combination with one or more of the first through seventh aspects, process 800 includes identifying that the responder UE is the target of the COT-SI based at least in part on decoding the COT-SI.

In a ninth aspect, alone or in combination with one or more of the first through eighth aspects, the global identifier associated with the initiator UE is a COT sharing identifier indicated by the COT-SI.

In a tenth aspect, alone or in combination with one or more of the first through ninth aspects, the COT sharing identifier is associated only with the initiator UE and the responder UE.

In an eleventh aspect, alone or in combination with one or more of the first through tenth aspects, the COT sharing identifier is associated with a group of UEs formed by the initiator UE.

In a twelfth aspect, alone or in combination with one or more of the first through eleventh aspects, process 800 includes identifying that the initiator UE is the target of the TB based at least in part on detecting the logical identifier associated with the TB in the COT-SI.

In a thirteenth aspect, alone or in combination with one or more of the first through twelfth aspects, the logical identifier associated with the TB is associated with one of a layer 1 source and destination identifier pair associated with a unicast message, or a layer 2 source and destination identifier pair associated with the unicast message.

In a fourteenth aspect, alone or in combination with one or more of the first through thirteenth aspects, the logical identifier associated with the TB is associated with one of a layer 1 destination identifier associated with one of a groupcast message or a broadcast message, or a layer 2 destination identifier associated with the one of the groupcast message or the broadcast message.

In a fifteenth aspect, alone or in combination with one or more of the first through fourteenth aspects, process 800 includes mapping the global identifier associated with the initiator UE to multiple unicast logical identifiers associated with multiple unicast sessions between the responder UE and the initiator UE.

In a sixteenth aspect, alone or in combination with one or more of the first through fifteenth aspects, the global identifier is a COT sharing identifier, and, for each of the multiple unicast sessions, an indication of the COT sharing identifier is received by the responder UE from the initiator UE.

In a seventeenth aspect, alone or in combination with one or more of the first through sixteenth aspects, the COT sharing identifier is a device identifier associated with the initiator UE.

In an eighteenth aspect, alone or in combination with one or more of the first through seventeenth aspects, process 800 includes maintaining a mapping of the global identifier and multiple logical identifiers in one of a MAC layer associated with the responder UE or a PHY layer associated with the responder UE.

In a nineteenth aspect, alone or in combination with one or more of the first through eighteenth aspects, the mapping of the global identifier and the multiple logical identifiers is maintained in the MAC layer associated with the responder UE, and identifying that the initiator UE is the target of TB is performed by the MAC layer associated with the responder UE.

In a twentieth aspect, alone or in combination with one or more of the first through nineteenth aspects, the mapping of the global identifier and the multiple logical identifiers is maintained in the PHY layer associated with the responder UE, and identifying that the initiator UE is the target of TB is performed by the PHY layer associated with the responder UE.

In a twenty-first aspect, alone or in combination with one or more of the first through twentieth aspects, the logical identifier associated with the TB is a layer 2 logical identifier, and the MAC layer indicates the layer 2 logical identifier to the PHY layer.

In a twenty-second aspect, alone or in combination with one or more of the first through twenty-first aspects, process 800 includes mapping the global identifier associated with the initiator UE to multiple group destination logical identifiers associated with the responder UE.

In a twenty-third aspect, alone or in combination with one or more of the first through twenty-second aspects, process 800 includes receiving, from the initiator UE, multiple COT-SIs, wherein each COT-SI, of the multiple COT-SIs, indicates a COT sharing identifier and one or more corresponding logical identifiers, and mapping, to the COT sharing identifier, the one or more corresponding logical identifiers associated with each COT-SI, of the multiple COT-SIs.

In a twenty-fourth aspect, alone or in combination with one or more of the first through twenty-third aspects, process 800 includes maintaining a mapping of the global identifier and multiple layer 2 logical identifiers, and updating the mapping of the global identifier and the multiple layer 2 logical identifiers based at least in part on a layer 2 logical identifier, of the multiple layer 2 logical identifiers, being changed to another layer 2 logical identifier.

In a twenty-fifth aspect, alone or in combination with one or more of the first through twenty-fourth aspects, the COT-SI includes an identifier field indicating one or more identifiers, and the one or more identifiers includes at least one of a COT sharing identifier, a group destination identifier, or a unicast source and destination identifier pair.

In a twenty-sixth aspect, alone or in combination with one or more of the first through twenty-fifth aspects, process 800 includes identifying whether an identifier, of the one or more identifiers, is the COT sharing identifier based at least in part on an indicator associated with the identifier.

In a twenty-seventh aspect, alone or in combination with one or more of the first through twenty-sixth aspects, process 800 includes identifying whether an identifier, of the one or more identifiers, is the COT sharing identifier based at least in part on identifying whether the identifier is associated with a string of zero bits.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by an initiator UE, in accordance with the present disclosure. Example process 900 is an example where the initiator UE (e.g., initiator UE 705) performs operations associated with using a shared COT across multiple sessions or casts.

As shown in FIG. 9, in some aspects, process 900 may include transmitting, to a responder UE, a COT-SI indicating resources associated with a COT and at least one of a global identifier associated with the initiator UE, or one or more logical identifiers associated with the COT (block 910). For example, the initiator UE (e.g., using transmission component 1004 and/or communication manager 1006, depicted in FIG. 10) may transmit, to a responder UE, a COT-SI indicating resources associated with a COT and at least one of a global identifier associated with the initiator UE, or one or more logical identifiers associated with the COT, as described above.

As further shown in FIG. 9, in some aspects, process 900 may include receiving, from the responder UE, a TB using the resources associated with the COT based at least in part on at least one of: a mapping of a logical identifier associated with the TB to the global identifier associated with the initiator UE, or a mapping of a logical identifier associated with the TB to a logical identifier indicated by the COT-SI (block 920). For example, the initiator UE (e.g., using reception component 1002 and/or communication manager 1006, depicted in FIG. 10) may receive, from the responder UE, a TB using the resources associated with the COT based at least in part on at least one of: a mapping of a logical identifier associated with the TB to the global identifier associated with the initiator UE, or a mapping of a logical identifier associated with the TB to a logical identifier indicated by the COT-SI, as described above.

Process 900 may include additional aspects, such as any single aspect or any combination of aspects described below and/or in connection with one or more other processes described elsewhere herein.

In a first aspect, the COT-SI indicates that the responder UE is a target of the COT-SI.

In a second aspect, alone or in combination with the first aspect, the COT-SI includes a COT sharing identifier indicating that the responder UE is a target of the COT-SI.

In a third aspect, alone or in combination with one or more of the first and second aspects, the COT sharing identifier is associated only with the initiator UE and the responder UE.

In a fourth aspect, alone or in combination with one or more of the first through third aspects, the COT sharing identifier is associated with a group of UEs, and the responder UE is associated with the group of UEs.

In a fifth aspect, alone or in combination with one or more of the first through fourth aspects, the COT-SI indicates that the responder UE is a target of the COT-SI based at least in part on including a logical identifier in the COT-SI that is associated with the responder UE.

In a sixth aspect, alone or in combination with one or more of the first through fifth aspects, the logical identifier in the COT-SI is associated with one of a layer 1 source and destination identifier pair associated with a unicast message, or a layer 2 source and destination identifier pair associated with the unicast message.

In a seventh aspect, alone or in combination with one or more of the first through sixth aspects, the logical identifier in the COT-SI is associated with one of a layer 1 destination identifier associated with one of a groupcast message or a broadcast message, or a layer 2 destination identifier associated with the one of the groupcast message or the broadcast message.

In an eighth aspect, alone or in combination with one or more of the first through seventh aspects, the COT-SI indicates that the responder UE is a target of the COT-SI based at least in part on a capability of the responder UE to decode the COT-SI.

In a ninth aspect, alone or in combination with one or more of the first through eighth aspects, the global identifier associated with the initiator UE is a COT sharing identifier indicated by the COT-SI.

In a tenth aspect, alone or in combination with one or more of the first through ninth aspects, the COT sharing identifier is associated only with the initiator UE and the responder UE.

In an eleventh aspect, alone or in combination with one or more of the first through tenth aspects, the COT sharing identifier is associated with a group of UEs formed by the initiator UE.

In a twelfth aspect, alone or in combination with one or more of the first through eleventh aspects, receiving the TB is further based at least in part on including the logical identifier associated with the TB in the COT-SI.

In a thirteenth aspect, alone or in combination with one or more of the first through twelfth aspects, the logical identifier associated with the TB is associated with one of a layer 1 source and destination identifier pair associated with a unicast message, or a layer 2 source and destination identifier pair associated with the unicast message.

In a fourteenth aspect, alone or in combination with one or more of the first through thirteenth aspects, the logical identifier associated with the TB is associated with one of a layer 1 destination identifier associated with one of a groupcast message or a broadcast message, or a layer 2 destination identifier associated with the one of the groupcast message or the broadcast message.

In a fifteenth aspect, alone or in combination with one or more of the first through fourteenth aspects, receiving the TB is further based at least in part on a mapping of the global identifier associated with the initiator UE to multiple unicast logical identifiers associated with multiple unicast sessions between the responder UE and the initiator UE.

In a sixteenth aspect, alone or in combination with one or more of the first through fifteenth aspects, the global identifier is a COT sharing identifier, and, for each of the multiple unicast sessions, an indication of the COT sharing identifier is transmitted by the initiator UE to the responder UE.

In a seventeenth aspect, alone or in combination with one or more of the first through sixteenth aspects, the COT sharing identifier is a device identifier associated with the initiator UE.

In an eighteenth aspect, alone or in combination with one or more of the first through seventeenth aspects, receiving the TB is further based at least in part on a mapping of the global identifier associated with the initiator UE to multiple group destination logical identifiers associated with the responder UE.

In a nineteenth aspect, alone or in combination with one or more of the first through eighteenth aspects, the COT-SI includes an identifier field indicating one or more identifiers, and the one or more identifiers includes at least one of a COT sharing identifier, a group destination identifier, or a unicast source and destination identifier pair.

In a twentieth aspect, alone or in combination with one or more of the first through nineteenth aspects, process 900 includes indicating whether an identifier, of the one or more identifiers, is the COT sharing identifier based at least in part on an indicator field associated with the identifier.

In a twenty-first aspect, alone or in combination with one or more of the first through twentieth aspects, process 900 includes indicating whether an identifier, of the one or more identifiers, is the COT sharing identifier based at least in part on whether the identifier is associated with a string of zero bits.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE (e.g., initiator UE 705, responder UE 710), or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE (e.g., initiator UE 705, responder UE 710) or a network node (such as a CU, a DU, an RU, or a base station), using the reception component 1002 and the transmission component 1004.

In some aspects, the apparatus 1000 may be configured to perform one or more operations described herein in connection with FIGS. 7A-7N. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE 120 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE 120 described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE 120 described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from an initiator UE, a COT-SI indicating resources associated with a COT. The communication manager 1006 may identify that the initiator UE is a target of a TB based at least in part on at least one of mapping a logical identifier associated with the TB to a global identifier associated with the initiator UE, or mapping the logical identifier associated with the TB to a logical identifier indicated by the COT-SI. The transmission component 1004 may transmit the TB to the initiator UE using the resources associated with the COT based at least in part on identifying that the initiator UE is the target of the TB.

The communication manager 1006 may identify that the responder UE is a target of the COT-SI, wherein transmitting the TB to the initiator UE using the resources associated with the COT is further based at least in part on identifying that the responder UE is the target of the COT-SI.

The communication manager 1006 may identify that the responder UE is the target of the COT-SI based at least in part on a COT sharing identifier indicated by the COT-SI.

The communication manager 1006 may identify that the responder UE is the target of the COT-SI based at least in part on detecting a logical identifier in the COT-SI that is associated with the responder UE.

The communication manager 1006 may identify that the responder UE is the target of the COT-SI based at least in part on decoding the COT-SI.

The communication manager 1006 may identify that the initiator UE is the target of the TB based at least in part on detecting the logical identifier associated with the TB in the COT-SI.

The communication manager 1006 may map the global identifier associated with the initiator UE to multiple unicast logical identifiers associated with multiple unicast sessions between the responder UE and the initiator UE.

The communication manager 1006 may maintain a mapping of the global identifier and multiple logical identifiers in one of a MAC layer associated with the responder UE or a PHY layer associated with the responder UE.

The communication manager 1006 may map the global identifier associated with the initiator UE to multiple group destination logical identifiers associated with the responder UE.

The reception component 1002 may receive, from the initiator UE, multiple COT-SIs, wherein each COT-SI, of the multiple COT-SIs, indicates a COT sharing identifier and one or more corresponding logical identifiers.

The communication manager 1006 may map, to the COT sharing identifier, the one or more corresponding logical identifiers associated with each COT-SI, of the multiple COT-SIs.

The communication manager 1006 may maintain a mapping of the global identifier and multiple layer 2 logical identifiers.

The communication manager 1006 may update the mapping of the global identifier and the multiple layer 2 logical identifiers based at least in part on a layer 2 logical identifier, of the multiple layer 2 logical identifiers, being changed to another layer 2 logical identifier.

The communication manager 1006 may identify whether an identifier, of the one or more identifiers, is the COT sharing identifier based at least in part on an indicator associated with the identifier.

The communication manager 1006 may identify whether an identifier, of the one or more identifiers, is the COT sharing identifier based at least in part on identifying whether the identifier is associated with a string of zero bits.

The transmission component 1004 may transmit, to a responder UE, a COT-SI indicating resources associated with a COT and at least one of a global identifier associated with the initiator UE, or one or more logical identifiers associated with the COT. The reception component 1002 may receive, from the responder UE, a TB using the resources associated with the COT based at least in part on at least one of a mapping of a logical identifier associated with the TB to the global identifier associated with the initiator UE, or a mapping of a logical identifier associated with the TB to a logical identifier indicated by the COT-SI.

The communication manager 1006 may indicate whether an identifier, of the one or more identifiers, is the COT sharing identifier based at least in part on an indicator field associated with the identifier.

The communication manager 1006 may indicate whether an identifier, of the one or more identifiers, is the COT sharing identifier based at least in part on whether the identifier is associated with a string of zero bits.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a responder UE, comprising: receiving, from an initiator UE, a COT-SI indicating resources associated with a COT; identifying that the initiator UE is a target of a TB based at least in part on at least one of: mapping a logical identifier associated with the TB to a global identifier associated with the initiator UE, or mapping the logical identifier associated with the TB to a logical identifier indicated by the COT-SI; and transmitting the TB to the initiator UE using the resources associated with the COT based at least in part on identifying that the initiator UE is the target of the TB.
Aspect 2: The method of Aspect 1, further comprising identifying that the responder UE is a target of the COT-SI, wherein transmitting the TB to the initiator UE using the resources associated with the COT is further based at least in part on identifying that the responder UE is the target of the COT-SI.
Aspect 3: The method of Aspect 2, further comprising identifying that the responder UE is the target of the COT-SI based at least in part on a COT sharing identifier indicated by the COT-SI.
Aspect 4: The method of Aspect 3, wherein the COT sharing identifier is associated only with the initiator UE and the responder UE.
Aspect 5: The method of Aspect 3, wherein the COT sharing identifier is associated with a group of UEs, and wherein the responder UE is associated with the group of UEs.
Aspect 6: The method of Aspect 2, further comprising identifying that the responder UE is the target of the COT-SI based at least in part on detecting a logical identifier in the COT-SI that is associated with the responder UE.
Aspect 7: The method of Aspect 6, wherein the logical identifier in the COT-SI is associated with one of a layer 1 source and destination identifier pair associated with a unicast message, or a layer 2 source and destination identifier pair associated with the unicast message.
Aspect 8: The method of Aspect 6, wherein the logical identifier in the COT-SI is associated with one of a layer 1 destination identifier associated with one of a groupcast message or a broadcast message, or a layer 2 destination identifier associated with the one of the groupcast message or the broadcast message.
Aspect 9: The method of Aspect 2, further comprising identifying that the responder UE is the target of the COT-SI based at least in part on decoding the COT-SI.
Aspect 10: The method of any of Aspects 1-9, wherein the global identifier associated with the initiator UE is a COT sharing identifier indicated by the COT-SI.
Aspect 11: The method of Aspect 10, wherein the COT sharing identifier is associated only with the initiator UE and the responder UE.
Aspect 12: The method of Aspect 10, wherein the COT sharing identifier is associated with a group of UEs formed by the initiator UE.
Aspect 13: The method of any of Aspects 1-12, further comprising identifying that the initiator UE is the target of the TB based at least in part on detecting the logical identifier associated with the TB in the COT-SI.
Aspect 14: The method of Aspect 13, wherein the logical identifier associated with the TB is associated with one of a layer 1 source and destination identifier pair associated with a unicast message, or a layer 2 source and destination identifier pair associated with the unicast message.
Aspect 15: The method of Aspect 13, wherein the logical identifier associated with the TB is associated with one of a layer 1 destination identifier associated with one of a groupcast message or a broadcast message, or a layer 2 destination identifier associated with the one of the groupcast message or the broadcast message.
Aspect 16: The method of any of Aspects 1-15, further comprising mapping the global identifier associated with the initiator UE to multiple unicast logical identifiers associated with multiple unicast sessions between the responder UE and the initiator UE.
Aspect 17: The method of Aspect 16, wherein the global identifier is a COT sharing identifier, and wherein, for each of the multiple unicast sessions, an indication of the COT sharing identifier is received by the responder UE from the initiator UE.
Aspect 18: The method of Aspect 17, wherein the COT sharing identifier is a device identifier associated with the initiator UE.
Aspect 19: The method of any of Aspects 1-18, further comprising maintaining a mapping of the global identifier and multiple logical identifiers in one of a MAC layer associated with the responder UE or a PHY layer associated with the responder UE.
Aspect 20: The method of Aspect 19, wherein the mapping of the global identifier and the multiple logical identifiers is maintained in the MAC layer associated with the responder UE, and wherein identifying that the initiator UE is the target of TB is performed by the MAC layer associated with the responder UE.
Aspect 21: The method of Aspect 19, wherein the mapping of the global identifier and the multiple logical identifiers is maintained in the PHY layer associated with the responder UE, and wherein identifying that the initiator UE is the target of TB is performed by the PHY layer associated with the responder UE.
Aspect 22: The method of Aspect 21, wherein the logical identifier associated with the TB is a layer 2 logical identifier, and wherein the MAC layer indicates the layer 2 logical identifier to the PHY layer.
Aspect 23: The method of any of Aspects 1-22, further comprising mapping the global identifier associated with the initiator UE to multiple group destination logical identifiers associated with the responder UE.
Aspect 24: The method of any of Aspects 1-23, further comprising: receiving, from the initiator UE, multiple COT-SIs, wherein each COT-SI, of the multiple COT-SIs, indicates a COT sharing identifier and one or more corresponding logical identifiers; and mapping, to the COT sharing identifier, the one or more corresponding logical identifiers associated with each COT-SI, of the multiple COT-SIs.
Aspect 25: The method of any of Aspects 1-24, further comprising: maintaining a mapping of the global identifier and multiple layer 2 logical identifiers; and updating the mapping of the global identifier and the multiple layer 2 logical identifiers based at least in part on a layer 2 logical identifier, of the multiple layer 2 logical identifiers, being changed to another layer 2 logical identifier.
Aspect 26: The method of any of Aspects 1-25, wherein the COT-SI includes an identifier field indicating one or more identifiers, and wherein the one or more identifiers includes at least one of a COT sharing identifier, a group destination identifier, or a unicast source and destination identifier pair.
Aspect 27: The method of Aspect 26, further comprising identifying whether an identifier, of the one or more identifiers, is the COT sharing identifier based at least in part on an indicator associated with the identifier.
Aspect 28: The method of Aspect 26, further comprising identifying whether an identifier, of the one or more identifiers, is the COT sharing identifier based at least in part on identifying whether the identifier is associated with a string of zero bits.
Aspect 29: A method of wireless communication performed by an initiator UE, comprising: transmitting, to a responder UE, a COT-SI indicating resources associated with a COT and at least one of a global identifier associated with the initiator UE, or one or more logical identifiers associated with the COT; and receiving, from the responder UE, a TB using the resources associated with the COT based at least in part on at least one of: a mapping of a logical identifier associated with the TB to the global identifier associated with the initiator UE, or a mapping of a logical identifier associated with the TB to a logical identifier indicated by the COT-SI.
Aspect 30: The method of Aspect 29, wherein the COT-SI indicates that the responder UE is a target of the COT-SI.
Aspect 31: The method of Aspect 30, wherein the COT-SI includes a COT sharing identifier indicating that the responder UE is a target of the COT-SI.
Aspect 32: The method of Aspect 31, wherein the COT sharing identifier is associated only with the initiator UE and the responder UE.
Aspect 33: The method of Aspect 31, wherein the COT sharing identifier is associated with a group of UEs, and wherein the responder UE is associated with the group of UEs.
Aspect 34: The method of Aspect 30, wherein the COT-SI indicates that the responder UE is a target of the COT-SI based at least in part on including a logical identifier in the COT-SI that is associated with the responder UE.
Aspect 35: The method of Aspect 34, wherein the logical identifier in the COT-SI is associated with one of a layer 1 source and destination identifier pair associated with a unicast message, or a layer 2 source and destination identifier pair associated with the unicast message.
Aspect 36: The method of Aspect 34, wherein the logical identifier in the COT-SI is associated with one of a layer 1 destination identifier associated with one of a groupcast message or a broadcast message, or a layer 2 destination identifier associated with the one of the groupcast message or the broadcast message.
Aspect 37: The method of Aspect 30, wherein the COT-SI indicates that the responder UE is a target of the COT-SI based at least in part on a capability of the responder UE to decode the COT-SI.
Aspect 38: The method of any of Aspects 29-37, wherein the global identifier associated with the initiator UE is a COT sharing identifier indicated by the COT-SI.
Aspect 39: The method of Aspect 38, wherein the COT sharing identifier is associated only with the initiator UE and the responder UE.
Aspect 40: The method of Aspect 38, wherein the COT sharing identifier is associated with a group of UEs formed by the initiator UE.
Aspect 41: The method of any of Aspects 29-40, wherein receiving the TB is further based at least in part on including the logical identifier associated with the TB in the COT-SI.
Aspect 42: The method of Aspect 41, wherein the logical identifier associated with the TB is associated with one of a layer 1 source and destination identifier pair associated with a unicast message, or a layer 2 source and destination identifier pair associated with the unicast message.
Aspect 43: The method of Aspect 41, wherein the logical identifier associated with the TB is associated with one of a layer 1 destination identifier associated with one of a groupcast message or a broadcast message, or a layer 2 destination identifier associated with the one of the groupcast message or the broadcast message.
Aspect 44: The method of any of Aspects 29-43, wherein receiving the TB is further based at least in part on a mapping of the global identifier associated with the initiator UE to multiple unicast logical identifiers associated with multiple unicast sessions between the responder UE and the initiator UE.
Aspect 45: The method of Aspect 44, wherein the global identifier is a COT sharing identifier, and wherein, for each of the multiple unicast sessions, an indication of the COT sharing identifier is transmitted by the initiator UE to the responder UE.
Aspect 46: The method of Aspect 45, wherein the COT sharing identifier is a device identifier associated with the initiator UE.
Aspect 47: The method of any of Aspects 29-46, wherein receiving the TB is further based at least in part on a mapping of the global identifier associated with the initiator UE to multiple group destination logical identifiers associated with the responder UE.
Aspect 48: The method of any of Aspects 29-47, wherein the COT-SI includes an identifier field indicating one or more identifiers, and wherein the one or more identifiers includes at least one of a COT sharing identifier, a group destination identifier, or a unicast source and destination identifier pair.
Aspect 49: The method of Aspect 48, further comprising indicating whether an identifier, of the one or more identifiers, is the COT sharing identifier based at least in part on an indicator field associated with the identifier.
Aspect 50: The method of Aspect 48, further comprising indicating whether an identifier, of the one or more identifiers, is the COT sharing identifier based at least in part on whether the identifier is associated with a string of zero bits.
Aspect 51: A method of wireless communication performed by a responder user equipment (UE), comprising: receiving, from an initiator UE, a channel occupancy time (COT) sharing information (COT-SI) indicating resources associated with a COT; identifying that the initiator UE is a target of a transport block (TB) based at least in part on mapping a link identifier associated with the TB to a logical identifier indicated by the COT-SI; and transmitting the TB to the initiator UE using the resources associated with the COT based at least in part on identifying that the initiator UE is the target of the TB.
Aspect 52: The method of Aspect 51, further comprising identifying that the responder UE is a target of the COT-SI, wherein transmitting the TB to the initiator UE using the resources associated with the COT is further based at least in part on identifying that the responder UE is the target of the COT-SI.
Aspect 53: The method of Aspect 52, further comprising identifying that the responder UE is the target of the COT-SI based at least in part on detecting a link identifier in the COT-SI that is associated with the responder UE.
Aspect 54: The method of Aspect 53, wherein the link identifier in the COT-SI is associated with one of a layer 1 source and destination identifier pair associated with a unicast message, or a layer 2 source and destination identifier pair associated with the unicast message.
Aspect 55: The method of Aspect 53, wherein the link identifier in the COT-SI is associated with one of a layer 1 destination identifier associated with one of a groupcast message or a broadcast message, or a layer 2 destination identifier associated with the one of the groupcast message or the broadcast message.
Aspect 56: The method of any of Aspects 51-55, wherein the link identifier associated with the TB is associated with one of a layer 1 source and destination identifier pair associated with a unicast message, or a layer 2 source and destination identifier pair associated with the unicast message.
Aspect 57: The method of any of Aspects 51-55, wherein the link identifier associated with the TB is associated with one of a layer 1 destination identifier associated with one of a groupcast message or a broadcast message, or a layer 2 destination identifier associated with the one of the groupcast message or the broadcast message.
Aspect 58: The method of any of Aspects 51-57, wherein the COT-SI includes an identifier field indicating the logical identifier, and wherein the logical identifier is one of a group destination identifier or a unicast source and destination identifier pair.
Aspect 59: A method of wireless communication performed by an initiator user equipment (UE), comprising: transmitting, to a responder UE, a channel occupancy time (COT) sharing information (COT-SI) indicating resources associated with a COT and one or more logical identifiers associated with the COT; and receiving, from the responder UE, a transport block (TB) using the resources associated with the COT based at least in part on a mapping of a link identifier associated with the TB to a logical identifier indicated by the COT-SI.
Aspect 60: The method of Aspect 59, wherein the COT-SI indicates that the responder UE is a target of the COT-SI.
Aspect 61: The method of Aspect 60, wherein the COT-SI indicates that the responder UE is a target of the COT-SI based at least in part on including a link identifier in the COT-SI that is associated with the responder UE.
Aspect 62: The method of Aspect 61, wherein the link identifier in the COT-SI is associated with one of a layer 1 source and destination identifier pair associated with a unicast message, or a layer 2 source and destination identifier pair associated with the unicast message.
Aspect 63: The method of Aspect 61, wherein the link identifier in the COT-SI is associated with one of a layer 1 destination identifier associated with one of a groupcast message or a broadcast message, or a layer 2 destination identifier associated with the one of the groupcast message or the broadcast message.
Aspect 64: The method of any of Aspects 59-63, wherein the link identifier associated with the TB is associated with one of a layer 1 source and destination identifier pair associated with a unicast message, or a layer 2 source and destination identifier pair associated with the unicast message.
Aspect 65: The method of any of Aspects 59-63, wherein the link identifier associated with the TB is associated with one of a layer 1 destination identifier associated with one of a groupcast message or a broadcast message, or a layer 2 destination identifier associated with the one of the groupcast message or the broadcast message.
Aspect 66: The method of any of Aspects 59-65, wherein the COT-SI includes an identifier field indicating the logical identifier, and wherein the logical identifier is one of a group destination identifier or a unicast source and destination identifier pair.
Aspect 67: An apparatus for wireless communication at a device, comprising a processor; memory coupled with the processor; and instructions stored in the memory and executable by the processor to cause the apparatus to perform the method of one or more of Aspects 1-66.
Aspect 68: A device for wireless communication, comprising a memory and one or more processors coupled to the memory, the one or more processors configured to perform the method of one or more of Aspects 1-66.
Aspect 69: An apparatus for wireless communication, comprising at least one means for performing the method of one or more of Aspects 1-66.
Aspect 70: A non-transitory computer-readable medium storing code for wireless communication, the code comprising instructions executable by a processor to perform the method of one or more of Aspects 1-66.
Aspect 71: A non-transitory computer-readable medium storing a set of instructions for wireless communication, the set of instructions comprising one or more instructions that, when executed by one or more processors of a device, cause the device to perform the method of one or more of Aspects 1-66.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A responder user equipment (UE) for wireless communication, comprising:
one or more memories; and
one or more processors, coupled to the one or more memories, individually or collectively configured to:
receive, from an initiator UE, a channel occupancy time (COT) sharing information (COT-SI) indicating resources associated with a COT;
identify that the initiator UE is a target of a transport block (TB) based at least in part on mapping a link identifier associated with the TB to a logical identifier indicated by the COT-SI; and
transmit the TB to the initiator UE using the resources associated with the COT based at least in part on identifying that the initiator UE is the target of the TB.

2. The responder UE of claim 1, wherein the one or more processors are further individually or collectively configured to identify that the responder UE is a target of the COT-Sf, wherein transmitting the TB to the initiator UE using the resources associated with the COT is further based at least in part on identifying that the responder UE is the target of the COT-SL

3. The responder UE of claim 2, wherein the one or more processors are further individually or collectively configured to identify that the responder UE is the target of the COT-Sf based at least in part on detecting a link identifier in the COT-SI that is associated with the responder UE.

4. The responder UE of claim 3, wherein the link identifier in the COT-SI is associated with one of a layer 1 source and destination identifier pair associated with a unicast message, or a layer 2 source and destination identifier pair associated with the unicast message.

5. The responder UE of claim 3, wherein the link identifier in the COT-SI is associated with one of a layer 1 destination identifier associated with one of a groupcast message or a broadcast message, or a layer 2 destination identifier associated with the one of the groupcast message or the broadcast message.

6. The responder UE of claim 1, wherein the link identifier associated with the TB is associated with one of a layer 1 source and destination identifier pair associated with a unicast message, or a layer 2 source and destination identifier pair associated with the unicast message.

7. The responder UE of claim 1, wherein the link identifier associated with the TB is associated with one of a layer 1 destination identifier associated with one of a groupcast message or a broadcast message, or a layer 2 destination identifier associated with the one of the groupcast message or the broadcast message.

8. The responder UE of claim 1, wherein the COT-SI includes an identifier field indicating the logical identifier, and wherein the logical identifier is one of a group destination identifier or a unicast source and destination identifier pair.

9. An initiator user equipment (UE) for wireless communication, comprising:
one or more memories; and
one or more processors, coupled to the one or more memories, individually or collectively configured to:
transmit, to a responder UE, a channel occupancy time (COT) sharing information (COT-SI) indicating resources associated with a COT and one or more logical identifiers associated with the COT; and
receive, from the responder UE, a transport block (TB) using the resources associated with the COT based at least in part on a mapping of a link identifier associated with the TB to a logical identifier indicated by the COT-SI.

10. The initiator UE of claim 9, wherein the COT-SI indicates that the responder UE is a target of the COT-SI.

11. The initiator UE of claim 10, wherein the COT-SI indicates that the responder UE is a target of the COT-SI based at least in part on including a link identifier in the COT-SI that is associated with the responder UE.

12. The initiator UE of claim 11, wherein the link identifier in the COT-SI is associated with one of a layer 1 source and destination identifier pair associated with a unicast message, or a layer 2 source and destination identifier pair associated with the unicast message.

13. The initiator UE of claim 11, wherein the link identifier in the COT-SI is associated with one of a layer 1 destination identifier associated with one of a groupcast message or a broadcast message, or a layer 2 destination identifier associated with the one of the groupcast message or the broadcast message.

14. The initiator UE of claim 9, wherein the link identifier associated with the TB is associated with one of a layer 1 source and destination identifier pair associated with a unicast message, or a layer 2 source and destination identifier pair associated with the unicast message.

15. The initiator UE of claim 9, wherein the link identifier associated with the TB is associated with one of a layer 1 destination identifier associated with one of a groupcast message or a broadcast message, or a layer 2 destination identifier associated with the one of the groupcast message or the broadcast message.

16. The initiator UE of claim 9, wherein the COT-SI includes an identifier field indicating the logical identifier, and wherein the logical identifier is one of a group destination identifier or a unicast source and destination identifier pair.

17. A method of wireless communication performed by a responder user equipment (UE), comprising:
receiving, from an initiator UE, a channel occupancy time (COT) sharing information (COT-SI) indicating resources associated with a COT;
identifying that the initiator UE is a target of a transport block (TB) based at least in part on mapping a link identifier associated with the TB to a logical identifier indicated by the COT-SI; and
transmitting the TB to the initiator UE using the resources associated with the COT based at least in part on identifying that the initiator UE is the target of the TB.

18. The method of claim 17, further comprising identifying that the responder UE is a target of the COT-SI, wherein transmitting the TB to the initiator UE using the resources associated with the COT is further based at least in part on identifying that the responder UE is the target of the COT-SI.

19. The method of claim 18, further comprising identifying that the responder UE is the target of the COT-SI based at least in part on detecting a link identifier in the COT-SI that is associated with the responder UE.

20. The method of claim 19, wherein the link identifier in the COT-SI is associated with one of a layer 1 source and destination identifier pair associated with a unicast message, or a layer 2 source and destination identifier pair associated with the unicast message.

21-30. (canceled)
